(19) United States
(12) Patent Application Publication
(10) Pub. No.: US 2024/0360274 A1
(43) Pub. Date: Oct. 31, 2024

(54) LIQUID CRYSTALLINE POLYESTER POWDER, PRODUCTION METHOD THEREFOR, LIQUID CRYSTALLINE POLYESTER COMPOSITION, LIQUID CRYSTALLINE POLYESTER FILM, PRODUCTION METHOD THEREFOR, LAMINATE, AND PRODUCTION METHOD THEREFOR

(71) Applicant: SUMITOMO CHEMICAL COMPANY, LIMITED, Tokyo (JP)

(72) Inventors: Shohei AZAMI, Tsukuba-shi (JP); Toyonari ITO, Tokyo (JP)

(73) Assignee: SUMITOMO CHEMICAL COMPANY, LIMITED, Tokyo (JP)

(21) Appl. No.: 18/682,506

(22) PCT Filed: Aug. 10, 2022
(86) PCT No.: PCT/JP2022/030524

§ 371 Date: Feb. 9, 2024

(30) Foreign Application Priority Data
Aug. 17, 2021 (JP) 2021-132632

(51) Int. Cl. C08G 63/60; C08G 63/78; C09J 5/06; C09J 7/35

(52) U.S. Cl. CPC C08G 63/605; C08G 63/78; C09J 5/06; C09J 7/35; C08G 2250/00; C09J 2301/304

(57) ABSTRACT

A liquid crystalline polyester powder comprising a liquid crystalline polyester having a structural unit derived from an aromatic diol and a structural unit derived from an aromatic dicarboxylic acid, wherein a molar ratio of the structural unit derived from an aromatic diol/the structural unit derived from an aromatic dicarboxylic acid in the liquid crystalline polyester is less than 1.

### TECHNICAL FIELD

The present invention relates to a liquid crystalline polyester powder and production method therefor, a liquid crystalline polyester composition, a liquid crystalline polyester film and production method therefor, and a laminate and production method therefor.

The present application claims priority based on Japanese Patent Application No. 2021-132632 filed in Japan on Aug. 17, 2021, the content of which is incorporated herein by reference in its entirety.

### BACKGROUND ART

A liquid crystalline polyester film has an excellent high frequency property and has a low water absorption property and thus attracts attention as an electronic substrate material.

For example, Patent Literature 1 discloses that, based on previous studies by inventors, it is possible to produce a liquid crystalline polyester film having suitable quality as a film for electronic components by applying a liquid crystalline polyester composition comprising a medium and a liquid crystalline polyester powder comprising a liquid crystalline polyester onto a support and heat-treating the composition.

### CITATION LIST

### Patent Literature

Patent Literature 1: International Publication No. WO 2020/166651

### SUMMARY OF INVENTION

### Problems to be Solved by Invention

A liquid crystalline polyester film can be provided as a laminate including it as an insulating material (for example, copper clad laminate (CCL), flexible copper clad laminate (FCCL), double-sided CCL having copper foils on both sides, and the like).

FIG. 5 is a schematic diagram showing an example of a production method for the liquid crystalline polyester film disclosed in Patent Literature 1, followed by an example of a production method for a laminate in the case where a laminate is produced. By applying a liquid crystalline polyester composition 30 containing a medium and a liquid crystalline polyester powder onto a first metal layer 14 and by drying and heat-treating the liquid crystalline polyester composition 30, a liquid crystalline polyester film 10 is obtained on the first metal layer 14. In the heat-treatment here, solid phase polymerization of the liquid crystalline polyester contained in the liquid crystalline polyester powder can progress.

Next, by the lamination method or other methods, the above first metal layer 14, the liquid crystalline polyester film 10, and a second metal layer 15 can be laminated, the liquid crystalline polyester film 10 can be heated to melt the liquid crystalline polyester, and the liquid crystalline polyester film 10 and the second metal layer 15 can be bonded together.

However, in the case where the bonding is carried out like this, for example, there is still room for studies on the state of adhesion (for example, adhesive strength) between the second metal layer and liquid crystalline polyester film bonded together.

The present inventors considered that insufficient melting of the liquid crystalline polyester contained in the liquid crystalline polyester film in heating at the time of lamination was one of the factors that reduced the adhesive strength of the liquid crystalline polyester film. It was found that the solid phase polymerization of the liquid crystalline polyester that may occur at the time of the above heat-treatment in the stage of obtaining the liquid crystalline polyester film raises the temperature of the endothermic peak detected by differential scanning calorimetry of the liquid crystalline polyester (the temperature that serves as an index of the temperature at which the liquid crystalline polyester is melted), which is a factor in the tendency for the liquid crystalline polyester to be melted insufficiently at the time of lamination.

The present invention was made to solve the problems as described above, and an object thereof is to provide a liquid crystalline polyester powder comprising a liquid crystalline polyester that is unlikely to cause a temperature increase in the endothermic peak detected by differential scanning calorimetry even after undergoing solid phase polymerization.

### Means to Solve the Problems

The present inventors have carried out diligent studies in order to solve the above problems and as a result, have found that by setting the molar ratio of a structural unit derived from an aromatic diol/a structural unit derived from an aromatic dicarboxylic acid in a liquid crystalline polyester to within a particular numerical range, a liquid crystalline polyester powder comprising a liquid crystalline polyester that is unlikely to cause the temperature increase in the endothermic peak even after undergoing solid phase polymerization can be obtained, and have completed the present invention.

That is, the present invention has the following aspects.

<1> A liquid crystalline polyester powder comprising a liquid crystalline polyester having a structural unit derived from an aromatic diol and a structural unit derived from an aromatic dicarboxylic acid,
wherein a molar ratio of the structural unit derived from an aromatic diol/the structural unit derived from an aromatic dicarboxylic acid in the liquid crystalline polyester is less than 1.

<2> The liquid crystalline polyester powder according to the <1>, wherein the liquid crystalline polyester has a flow starting temperature of 263° C. or lower.

<3> The liquid crystalline polyester powder according to the <1> or <2>, wherein the liquid crystalline polyester has a structural unit comprising a naphthalene structure.

<4> The liquid crystalline polyester powder according to the <3>, wherein a content of the structural unit comprising the naphthalene structure is 40 mol % or more based on 100 mol % of a total amount of all structural units in the liquid crystalline polyester.

<5> The liquid crystalline polyester powder according to any one of the <1> to <4>, wherein the liquid crystalline polyester has a structural unit represented by the following formula (1), a structural unit represented by the following formula (2), and a structural unit represented by the following formula (3):

—O-Ar1-CO— (1)

—CO—Ar2-CO— (2)

—O—Ar3-O— (3)
wherein Ar represents a 2,6-naphthylene group, a 1,4-phenylene group, or a 4,4′-biphenylylene group;
Ar2 and Ar3 each independently represent a 2,6-naphthylene group, a 2,7-naphthylene group, a 1,4-phenylene group, a 1,3-phenylene group, or a 4,4′-biphenylylene group; and
hydrogen atoms in the group represented by Ar1, Ar2, or Ar3 are each independently optionally replaced with a halogen atom, an alkyl group having 1 to 10 carbon atoms, or an aryl group having 6 to 20 carbon atoms.

<6> The liquid crystalline polyester powder according to the <5>, wherein a molar ratio of the structural unit represented by the formula (3)/the structural unit represented by the formula (2) in the liquid crystalline polyester is less than 1.

<7> A method for producing the liquid crystalline polyester powder according to any one of the <1> to <6>, comprising
a step of obtaining the liquid crystalline polyester by using the aromatic diol and the aromatic dicarboxylic acid as monomers,
wherein a molar ratio of the aromatic diol/the aromatic dicarboxylic acid is less than 1.

<8> A liquid crystalline polyester composition comprising a medium and the liquid crystalline polyester powder according to any one of the <1> to <6>.

<9> A method for producing a liquid crystalline polyester film, comprising: obtaining a liquid crystalline polyester film comprising the liquid crystalline polyester by applying the liquid crystalline polyester composition according to the <8> onto a first support and heat-treating the liquid crystalline polyester composition.

<10> A method for producing a laminate, comprising: obtaining a first laminate comprising a first support and a liquid crystalline polyester film by applying the liquid crystalline polyester composition according to the

<8> onto the first support and heat-treating the liquid crystalline polyester composition to form the liquid crystalline polyester film comprising the liquid crystalline polyester.

<11> The method for producing a laminate according to the <10>, comprising laminating a second support on the surface of the liquid crystalline polyester film of the first laminate opposite to a surface on which the first support is laminated, heating the liquid crystalline polyester film, and bonding the liquid crystalline polyester film and the second support together to obtain a second laminate.

<12> A liquid crystalline polyester film comprising a liquid crystalline polyester having a structural unit derived from an aromatic diol and a structural unit derived from an aromatic dicarboxylic acid,
wherein a molar ratio of the structural unit derived from an aromatic diol/the structural unit derived from an aromatic dicarboxylic acid in the liquid crystalline polyester is less than 1.

<13> The liquid crystalline polyester film according to the <12>, wherein the liquid crystalline polyester has a structural unit comprising a naphthalene structure.

<14> The liquid crystalline polyester film according to the <13>, wherein a content of the structural unit comprising a naphthalene structure is 40 mol % or more based on 100 mol % of a total amount of all structural units in the liquid crystalline polyester.

<15> The liquid crystalline polyester film according to any one of the <12> to <14>, wherein the liquid crystalline polyester has a structural unit represented by the following formula (1), a structural unit represented by the following formula (2), and a structural unit represented by the following formula (3):

—O—Ar1-CO— (1)

—CO—Ar2-CO— (2)

—O—Ar3-O— (3)
wherein Ar1 represents a 2,6-naphthylene group, a 1,4-phenylene group, or a 4,4′-biphenylylene group;
Ar2 and Ar3 each independently represent a 2,6-naphthylene group, a 2,7-naphthylene group, a 1,4-phenylene group, a 1,3-phenylene group, or a 4,4′-biphenylylene group; and
hydrogen atoms in the group represented by Ar1, Ar2, or Ar3 are each independently optionally replaced with a halogen atom, an alkyl group having 1 to 10 carbon atoms, or an aryl group having 6 to 20 carbon atoms.

<16> The liquid crystalline polyester film according to the <15>, wherein a molar ratio of the structural unit represented by the formula (3)/the structural unit represented by the formula (2) in the liquid crystalline polyester is less than 1.

<17> A laminate comprising a first metal layer and the liquid crystalline polyester film according to any one of the <12> to <16> laminated on the first metal layer.

<18> The laminate according to the <17>, comprising the first metal layer, the liquid crystalline polyester film according to any one of the <12> to <16> laminated on the first metal layer, and a second metal layer laminated on the surface of the liquid crystalline polyester film opposite to a surface on which the first metal layer is laminated.

### Effects of Invention

According to the present invention, it is possible to provide a liquid crystalline polyester powder comprising a liquid crystalline polyester that is unlikely to cause a temperature increase in the endothermic peak detected by differential scanning calorimetry even after undergoing solid phase polymerization.

In addition, according to the present invention, it is possible to provide a method for producing the liquid crystalline polyester powder.

In addition, according to the present invention, it is possible to provide a liquid crystalline polyester composition comprising a medium and the liquid crystalline polyester powder.

In addition, according to the present invention, it is possible to provide a liquid crystalline polyester film and a production method therefor using the liquid crystalline polyester composition, as well as a laminate and a production method therefor.

### BRIEF DESCRIPTION OF DRAWINGS

FIG. 1A is a schematic diagram showing a production process of the liquid crystalline polyester film, the first laminate and the second laminate according to one embodiment of the present invention.

FIG. 1B is a schematic diagram showing a production process of the liquid crystalline polyester film, the first laminate and the second laminate according to one embodiment of the present invention.

FIG. 1C is a schematic diagram showing a production process of the liquid crystalline polyester film, the first laminate and the second laminate according to one embodiment of the present invention.

FIG. 1D is a schematic diagram showing a production process of the second laminate according to one embodiment of the present invention.

FIG. 2 is a schematic diagram showing a configuration of the liquid crystalline polyester film according to one embodiment of the present invention.

FIG. 3 is a schematic diagram showing a configuration of the first laminate according to one embodiment of the present invention.

FIG. 4 is a schematic diagram showing a configuration of the second laminate of one embodiment of the present invention.

FIG. 5 is a schematic diagram showing an example of a production method for the liquid crystalline polyester film disclosed in Patent Literature 1, followed by an example of a production method for a laminate in the case where a laminate is produced.

### EMBODIMENTS FOR CARRYING OUT INVENTION

Hereinafter, embodiments of the liquid crystalline polyester powder and production method therefor, the liquid crystalline polyester composition, the liquid crystalline polyester film and production method therefor, and the laminate and production method therefor according to the present invention will be described.

### <<Liquid Crystalline Polyester Powder>>

The liquid crystalline polyester powder of the embodiment comprises a liquid crystalline polyester having a structural unit derived from an aromatic diol and a structural unit derived from an aromatic dicarboxylic acid, and
the molar ratio of the structural unit derived from an aromatic diol/the structural unit derived from an aromatic dicarboxylic acid in the liquid crystalline polyester is less than 1.

### (Liquid Crystalline Polyester)

The liquid crystalline polyester according to the present embodiment is a polyester that has a structural unit derived from an aromatic diol and a structural unit derived from an aromatic dicarboxylic acid, and exhibits liquid crystals in a molten state. The liquid crystalline polyester according to the present embodiment is preferably one that is melted at a temperature of 450° C. or lower. The liquid crystalline polyester may be a liquid crystalline polyester amide, a liquid crystalline polyester ether, a liquid crystalline polyester carbonate, or a liquid crystalline polyester imide. The liquid crystalline polyester is preferably a wholly aromatic liquid crystalline polyester having only a structural unit derived from an aromatic compound as a raw material monomer.

Typical examples of the liquid crystalline polyester include a polymer obtained by condensation polymerization (polycondensation) of an aromatic hydroxycarboxylic acid, an aromatic dicarboxylic acid, and at least one compound selected from the group consisting of an aromatic diol, an aromatic hydroxylamine, and an aromatic diamine; a polymer obtained by polymerizing a plurality of aromatic hydroxycarboxylic acids; a polymer obtained by polymerizing an aromatic dicarboxylic acid and at least one compound selected from the group consisting of an aromatic diol, an aromatic hydroxylamine, and an aromatic diamine; and a polymer obtained by polymerizing a polyester such as polyethylene terephthalate and an aromatic hydroxycarboxylic acid.

The liquid crystalline polyester according to the present embodiment has a structural unit derived from an aromatic diol and a structural unit derived from an aromatic dicarboxylic acid, and is preferably a polymer obtained by condensation polymerization (polycondensation) of an aromatic hydroxycarboxylic acid, an aromatic dicarboxylic acid, and at least one compound selected from the group consisting of an aromatic diol, an aromatic hydroxylamine, and an aromatic diamine, and more preferably a polymer obtained by condensation polymerization (polycondensation) of an aromatic hydroxycarboxylic acid, an aromatic dicarboxylic acid, and an aromatic diol.

Here, the aromatic hydroxycarboxylic acid, the aromatic dicarboxylic acid, the aromatic diol, the aromatic hydroxylamine, and the aromatic diamine may each independently be partially or completely substituted with a polymerizable ester-forming derivative thereof.

Examples of a polymerizable derivative of a compound having a carboxy group such as an aromatic hydroxycarboxylic acid and an aromatic dicarboxylic acid include an ester, an acid halide, and an acid anhydride.

Examples of the above ester include a compound obtained by converting the carboxy group into an alkoxycarbonyl group or an aryloxycarbonyl group. Examples of the above acid halide include a compound obtained by converting the carboxy group into a haloformyl group. Examples of the above acid anhydride include a compound obtained by converting the carboxy group into an acyloxycarbonyl group.

Examples of a polymerizable derivative of a compound having a hydroxyl group such as an aromatic hydroxycarboxylic acid, an aromatic diol, and an aromatic hydroxylamine include a compound obtained by acylating the hydroxyl group to convert the same into an acyloxy group (acylated product).

Examples of a polymerizable derivative of a compound having an amino group such as an aromatic hydroxylamine and an aromatic diamine include a compound obtained by acylating the amino group to convert the same into an acylamino group (acylated product).

Among the examples of the polymerizable derivatives given as examples, acylated products obtained by acylating an aromatic hydroxycarboxylic acid and an aromatic diol are preferable as a raw material monomer of the liquid crystalline polyester.

The liquid crystalline polyester according to the present embodiment has a structural unit derived from an aromatic diol and a structural unit derived from an aromatic dicarboxylic acid, and the molar ratio of the structural unit derived from an aromatic diol/the structural unit derived from an aromatic dicarboxylic acid in the liquid crystalline polyester is less than 1, preferably 0.95 or less, more preferably 0.93 or less, even more preferably 0.90 or less, and particularly preferably 0.88 or less.

The lower limit value of the molar ratio of the structural unit derived from an aromatic diol/the structural unit derived from an aromatic dicarboxylic acid in the liquid crystalline polyester according to the embodiment may be 0.70 or more, may be 0.75 or more, may be 0.8 or more, may be 0.81 or more, or may be 0.82 or more, from the viewpoint of making production of the liquid crystalline polyester more efficient.

An example of the above numerical range of the molar ratio of the structural unit derived from an aromatic diol/the structural unit derived from an aromatic dicarboxylic acid in the liquid crystalline polyester according to the present embodiment may be 0.70 or more and less than 1, may be 0.75 or more and 0.95 or less, may be 0.8 or more and 0.93 or less, may be 0.81 or more and 0.90 or less, or may be 0.82 or more and 0.88 or less.

In the case where the liquid crystalline polyester comprises structural units derived from multiple types of aromatic diols, the amount of substance of the structural unit derived from an aromatic diol in the above molar ratio is the sum of the amount of substance of the structural units derived from multiple types of aromatic diols.

Similarly, in the case where the liquid crystalline polyester comprises structural units derived from multiple types of aromatic dicarboxylic acids, the amount of substance of the structural unit derived from an aromatic dicarboxylic acid in the above molar ratio is the sum of the amount of substance of the structural units derived from multiple types of aromatic dicarboxylic acids.

The content of the structural unit derived from an aromatic diol and the structural unit derived from an aromatic dicarboxylic acid in the liquid crystalline polyester is preferably 20 to 100 mol %, more preferably 30 to 80 mol %, and even more preferably 40 to 60 mol %, based on 100 mol % of the total amount of all structural units in the liquid crystalline polyester (the value obtained by dividing the mass of each structural unit constituting the liquid crystalline polyester by the formula weight of that structural unit to determine the amount of substance equivalent (mol) of each structural unit, and then summing up the resulting values).

The structural unit derived from an aromatic diol at a terminal of the main chain of the polymerized liquid crystalline polyester can have, for example, a hydroxyl group that can react with a carboxy group. On the other hand, the structural unit derived from an aromatic dicarboxylic acid at a terminal of the main chain of the polymerized liquid crystalline polyester can have, for example, a carboxy group that can react with a hydroxyl group.

It is presumed that, by setting the molar ratio of the structural unit derived from an aromatic diol/the structural unit derived from an aromatic dicarboxylic acid in the liquid crystalline polyester to the above upper limit value or less, a balance between the equivalent amounts of functional groups of the polymerizable combination derived from the aromatic diol and aromatic dicarboxylic acid that remain at terminals of the main chain of the liquid crystalline polyester is disrupted, and in the case where the liquid crystalline polyester then undergoes solid phase polymerization, the progress of the polymerization reaction of the liquid crystalline polyester can be moderately suppressed.

Therefore, it is possible to provide a liquid crystalline polyester powder comprising a liquid crystalline polyester that is unlikely to cause a temperature increase in the endothermic peak detected by differential scanning calorimetry even after undergoing solid phase polymerization.

Even in the case where the proportion of the structural unit derived from an aromatic diol to the structural unit derived from an aromatic dicarboxylic acid is increased, a balance between the equivalent amounts of functional groups of the polymerizable combination is similarly disrupted, and in fact, compared to Comparative Example 1 described later, the temperature increase in the endothermic peak due to solid phase polymerization is more suppressed in Comparative Examples 2 to 3. However, its effectiveness is inferior to that of Examples 1 to 4.

That is, although the detailed reason is not clear, in the liquid crystalline polyester, a larger proportion of the structural unit derived from an aromatic dicarboxylic acid is excellent in the effect of suppressing the temperature increase in the endothermic peak compared to the case of a larger proportion of the structural unit derived from an aromatic diol.

The concept of being derived here also encompasses the case where the structural unit is derived from a polymerizable derivative of the compound. For example, the structural unit derived from an aromatic diol may be a structural unit derived from an acylated product of the aromatic diol.

In the case where a compound obtained by acylating a hydroxyl group and converting it into an acyloxy group (acylated product) is used as the polymerizable derivative, for example, the structural unit derived from an aromatic diol can have an acyloxy group that can react with a carboxy group.

The liquid crystalline polyester according to the embodiment preferably has a structural unit represented by the following formula (1) (hereinafter, sometimes referred to as a “structural unit (1)”):

—O—Ar1-CO— (1)
wherein Ar represents a divalent aromatic hydrocarbon group, and
   one or more hydrogen atoms in the group represented by Ar are each independently optionally replaced with a halogen atom, an alkyl group having 1 to 10 carbon atoms, or an aryl group having 6 to 20 carbon atoms.

For the liquid crystalline polyester according to the embodiment, in the structural unit represented by the following formula (1), Ar preferably represents a phenylene group, a naphthylene group, or a biphenylene group. From the viewpoint of having even more excellent dielectric properties, the liquid crystalline polyester according to the embodiment more preferably has the structural unit (1), a structural unit represented by the following formula (2) (hereinafter, sometimes referred to as a “structural unit (2)”), and a structural unit represented by the following formula (3) (hereinafter, sometimes referred to as a “structural unit (3)”).

—O—Ar1-CO— (1)

—CO—Ar2-CO— (2)

—O—Ar3-O— (3)
wherein Ar1, Ar2, and Ar3 each independently represent a naphthylene group, a phenylene group, or a biphenylylene group; and
hydrogen atoms in the group represented by Ar1, Ar2, or Ar3 are each independently optionally replaced with a halogen atom, an alkyl group having 1 to 10 carbon atoms, or an aryl group having 6 to 20 carbon atoms.

Examples of the halogen atom with which a hydrogen atom can be replaced include a fluorine atom, a chlorine atom, a bromine atom, and an iodine atom.

Examples of the alkyl group having 1 to 10 carbon atoms with which a hydrogen atom can be replaced include a methyl group, an ethyl group, a 1-propyl group, an isopropyl group, a 1-butyl group, an isobutyl group, a sec-butyl group, a tert-butyl group, a 1-hexyl group, a 2-ethylhexyl group, a 1-octyl group, and a 1-decyl group.

Examples of the aryl group having 6 to 20 carbon atoms with which a hydrogen atom can be replaced include a monocyclic aromatic group such as a phenyl group, an orthotolyl group, a metatolyl group, or a paratolyl group, and a condensed aromatic group such as a 1-naphthyl group or a 2-naphthyl group.

When one or more hydrogen atoms in the group represented by Ar1, Ar2, or Ar3 are replaced with the halogen atom, the alkyl group having 1 to 10 carbon atoms, or the aryl group having 6 to 20 carbon atoms, the number of groups replacing the hydrogen atoms for each group represented by Ar1, Ar2, or Ar3 is, independently in each group, preferably one or two and more preferably one.

The liquid crystalline polyester according to the embodiment preferably comprises a structural unit comprising a naphthalene structure. The liquid crystalline polyester comprising a structural unit comprising a naphthalene structure tends to have excellent dielectric properties.

In a liquid crystalline polyester having the above structural unit (1), the above structural unit (2), and the above structural unit (3) as a liquid crystalline polyester having a structural unit comprising a divalent naphthalene structure, at least one of a plurality of groups represented by Ar1, Ar2, and Ar3 is preferably a naphthylene group.

The content of the structural unit comprising a naphthalene structure in the liquid crystalline polyester is preferably 40 mol % or more, preferably 50 mol % or more, more preferably 55 mol % or more, and even more preferably 60 mol % or more, based on 100 mol % in total of all the structural units in the liquid crystalline polyester (the value of the sum of the amount of substance equivalent (mol) of each structural unit constituting the liquid crystalline polyester determined by dividing the mass of the structural unit by the formula mass of the each structural unit. Because the content of the structural unit comprising a naphthalene structure is equal to or more than the above lower limit value, the relative permittivity of the liquid crystalline polyester can be even more lowered.

The content of the structural unit comprising a naphthalene structure in the liquid crystalline polyester is preferably 90 mol % or less, more preferably 85 mol % or less, and even more preferably 80 mol % or less, per 100 mol % in total of all the structural units in the liquid crystalline polyester. Because the content of the structural unit comprising a naphthalene structure is equal to or less than the above upper limit value, the reaction stability at the time of producing the liquid crystalline polyester can be ensured.

An example of the numerical range of a value of the content of the structural unit comprising a naphthalene structure may be 40 mol % or more and 90 mol % or less, 50 mol % or more and 85 mol % or less, 55 mol % or more and 85 mol % or less, or 60 mol % or more and 80 mol % or less.

The liquid crystalline polyester having the above structural units (1) to (3) more preferably has a structural unit represented by the following formula (1), a structural unit represented by the following formula (2), and a structural unit represented by the following formula (3):

—O—Ar1-CO— (1)

—CO—Ar2-CO— (2)

—O—Ar3-O— (3)
wherein Ar represents a 2,6-naphthylene group, a 1,4-phenylene group, or a 4,4′-biphenylylene group;
Ar2 and Ar3 each independently represent a 2,6-naphthylene group, a 2,7-naphthylene group, a 1,4-phenylene group, a 1,3-phenylene group, or a 4,4′-biphenylylene group; and
hydrogen atoms in the group represented by Ar1, Ar2, or Ar3 are each independently optionally replaced with a halogen atom, an alkyl group having 1 to 10 carbon atoms, or an aryl group having 6 to 20 carbon atoms.

For the liquid crystalline polyester, Ar1 preferably represents a 2,6-naphthylene group or a 1,4-phenylene group, and Ar2 and Ar3 preferably each independently represent a 2,6-naphthylene group, a 2,7-naphthylene group, a 1,4-phenylene group, or a 1,3-phenylene group. (Hydrogen atoms in the group represented by Ar1, Ar2, or Ar3 are each independently optionally replaced with a halogen atom, an alkyl group having 1 to 10 carbon atoms, or an aryl group having 6 to 20 carbon atoms.)

For the liquid crystalline polyester, Ar1 preferably represents a 2,6-naphthylene group, and Ar2 and Ar3 preferably each independently represent a 2,6-naphthylene group or a 1,4-phenylene group. (Hydrogen atoms in the group represented by Ar1, Ar2, or Ar3 are each independently optionally replaced with a halogen atom, an alkyl group having 1 to 10 carbon atoms, or an aryl group having 6 to 20 carbon atoms.)

The structural unit represented by the formula (3) corresponds to the structural unit derived from an aromatic diol. The structural unit represented by the formula (2) corresponds to the structural unit derived from an aromatic dicarboxylic acid.

For the liquid crystalline polyester having the above structural units (1) to (3), Ar and/or Ar2 is preferably a 2,6-naphthylene group.

The liquid crystalline polyester according to the embodiment may contain the structural units in which Ar1 and/or Ar2 is a 2,6-naphthylene group in the structural units represented by the above formula (1) and the above formula (2) in an amount of 40 mol % or more, 40 mol % or more and 90 mol % or less, 50 mol % or more and 85 mol % or less, 55 mol % or more and 85 mol % or less, or 60 mol % or more and 80 mol % or less, based on the total amount of all structural units in the liquid crystalline polyester.

The structural unit (1) is a structural unit derived from an aromatic hydroxycarboxylic acid.

Examples of the aromatic hydroxycarboxylic acid include para-hydroxy benzoic acid, metahydroxybenzoic acid, 2-hydroxy-6-naphthoic acid, 2-hydroxy-3-naphthoic acid, 1-hydroxy-5-naphthoic acid, 4-hydroxy-4′-carboxydiphenyl ether, or an aromatic hydroxycarboxylic acid obtained by partially replacing the hydrogen atoms in the aromatic ring of such an aromatic hydroxycarboxylic acid listed above with a substituent selected from the group consisting of an alkyl group, an aryl group, and a halogen atom. The aromatic hydroxycarboxylic acids may be used singly or in combinations of two or more in the production of the liquid crystalline polyester.

As the structural unit (1), one in which Ar1 is a 1,4-phenylene group (for example, a structural unit derived from 4-hydroxybenzoic acid) and one in which Ar1 is a 2,6-naphthylene group (for example, a structural unit derived from 6-hydroxy-2-naphthoic acid) are preferable.

The structural unit (2) is a structural unit derived from an aromatic dicarboxylic acid.

Examples of the aromatic dicarboxylic acid include terephthalic acid, isophthalic acid, biphenyl-4,4′-dicarboxylic acid, 2,6-naphthalenedicarboxylic acid, diphenyl ether-4,4′-dicarboxylic acid, and diphenyl thioether-4,4′-dicarboxylic acid, and an aromatic dicarboxylic acid obtained by partially replacing the hydrogen atoms in the aromatic ring of such an aromatic dicarboxylic acid listed above with a substituent selected from the group consisting of an alkyl group, an aryl group, and a halogen atom.

The aromatic dicarboxylic acids may be used singly or in combinations of two or more in the production of the liquid crystalline polyester.

As the structural unit (2), one in which Ar2 is a 1,4-phenylene group (for example, a structural unit derived from terephthalic acid), one in which Ar2 is a 1,3-phenylene group (for example, a structural unit derived from isophthalic acid), one in which Ar2 is a 2,6-naphthylene group (for example, a structural unit derived from 2,6-naphthalenedicarboxylic acid), and one in which Ar2 is a diphenyl ether-4,4′-diyl group (for example, a structural unit derived from diphenyl ether-4,4′-dicarboxylic acid) are preferable.

The structural unit (3) is a structural unit derived from an aromatic diol, an aromatic hydroxylamine, or an aromatic diamine.

Examples of the aromatic diol, the aromatic hydroxylamine, or the aromatic diamine include 4,4′-dihydroxybiphenyl, hydroquinone, methylhydroquinone, resorcin, 4,4′-dihydroxydiphenyl ketone, 4,4′-dihydroxydiphenyl ether, bis(4-hydroxyphenyl)methane, 1,2-bis(4-hydroxyphenyl)ethane, 4,4′-dihydroxydiphenylsulfone, 4,4′-dihydroxydiphenyl thioether, 2,6-dihydroxynaphthalene, 1,5-dihydroxynaphthalene, 4-aminophenol, 1,4-phenylenediamine, 4-amino-4′-hydroxybiphenyl, and 4,4′-diaminobiphenyl.

The aromatic diols, the aromatic hydroxylamines, or the aromatic diamines may be used singly or in combinations of two or more in the production of the liquid crystalline polyester.

As the structural unit (3), one in which Ar3 is a 1,4-phenylene group (for example, a structural unit derived from hydroquinone, 4-aminophenol, or 1,4-phenylenediamine) and one in which Ar3 is a 4,4′-biphenylylene group (for example, a structural unit derived from 4,4′-dihydroxybiphenyl, 4-amino-4′-hydroxybiphenyl, or 4,4′-diaminobiphenyl) are preferable.

In the present description, “derived” means that the chemical structure is changed for the polymerization of the raw material monomer, and no other changes of structure occur.

The concept of being derived here also encompasses the case where the structural unit is derived from a polymerizable derivative of the compound, and for example, each structural unit may be a structural unit derived from acylated products of the aromatic hydroxycarboxylic acid, the aromatic diol, and the aromatic hydroxylamine.

When the liquid crystalline polyester film of the embodiment is required to have particularly good heat resistance, the number of these substituents is preferably small, and particularly it is preferable not to have a substituent such as an alkyl group.

Next, liquid crystalline polyesters particularly suitable for application to the liquid crystalline polyester powder of the embodiment will be given as examples below.

Specific examples of the preferable liquid crystalline polyesters include copolymers consisting of structural units derived from the following combinations of monomers.
1) 4-Hydroxybenzoic acid/2-hydroxy-6-naphthoic acid copolymer
2) 4-Hydroxybenzoic acid/terephthalic acid/4,4′-dihydroxybiphenyl copolymer
3) 4-Hydroxybenzoic acid/terephthalic acid/isophthalic acid/4,4′-dihydroxybiphenyl copolymer
4) 4-Hydroxybenzoic acid/terephthalic acid/isophthalic acid/4,4′-dihydroxybiphenyl/hydroquinone copolymer
5) 4-Hydroxybenzoic acid/terephthalic acid/hydroquinone copolymer
6) 2-Hydroxy-6-naphthoic acid/terephthalic acid/hydroquinone copolymer
7) 2-Hydroxy-6-naphthoic acid/terephthalic acid/2,6-naphthalenedicarboxylic acid/hydroquinone copolymer
8) 4-Hydroxybenzoic acid/2-hydroxy-6-naphthoic acid/terephthalic acid copolymer
9) 4-Hydroxybenzoic acid/2-hydroxy-6-naphthoic acid/isophthalic acid copolymer
10) 4-Hydroxybenzoic acid/2-hydroxy-6-naphthoic acid/terephthalic acid/4,4′-dihydroxybiphenyl copolymer
11) 4-Hydroxybenzoic acid/2-hydroxy-6-naphthoic acid/isophthalic acid/4,4′-dihydroxybiphenyl copolymer
12) 4-Hydroxybenzoic acid/2-hydroxy-6-naphthoic acid/terephthalic acid/2,6-naphthalenedicarboxylic acid/4,4′-dihydroxybiphenyl copolymer
13) 4-Hydroxybenzoic acid/2-hydroxy-6-naphthoic acid/terephthalic acid/4,4′-dihydroxybiphenyl/methylhydroquinone copolymer
14) 2-Hydroxy-6-naphthoic acid/terephthalic acid/4,4′-dihydroxybiphenyl copolymer
15) 2-Hydroxy-6-naphthoic acid/terephthalic acid/isophthalic acid/4,4′-dihydroxybiphenyl copolymer
16) 2-Hydroxy-6-naphthoic acid/terephthalic acid/2,6-naphthalenedicarboxylic acid/4,4′-dihydroxybiphenyl copolymer
17) 2-Hydroxy-6-naphthoic acid/terephthalic acid/isophthalic acid/2,6-naphthalenedicarboxylic acid/4,4′-dihydroxybiphenyl copolymer
18) 4-hydroxybenzoic acid/2-hydroxy-6-naphthoic acid/terephthalic acid/hydroquinone copolymer
19) 4-hydroxybenzoic acid/2-hydroxy-6-naphthoic acid/terephthalic acid/3,3′-dimethyl-1,1′-biphenyl-4,4′-diol copolymer
20) 4-Hydroxybenzoic acid/2-hydroxy-6-naphthoic acid/terephthalic acid/hydroquinone/4,4′-dihydroxybiphenyl copolymer
21) 4-Hydroxybenzoic acid/2,6-naphthalenedicarboxylic acid/4,4′-dihydroxybiphenyl copolymer
22) 4-Hydroxybenzoic acid/terephthalic acid/2,6-naphthalenedicarboxylic acid/hydroquinone copolymer
23) 4-Hydroxybenzoic acid/2,6-naphthalenedicarboxylic acid/hydroquinone copolymer
24) 4-Hydroxybenzoic acid/2-hydroxy-6-naphthoic acid/2,6-naphthalenedicarboxylic acid/hydroquinone copolymer
25) 4-Hydroxybenzoic acid/terephthalic acid/2,6-naphthalenedicarboxylic acid/hydroquinone/4,4′-dihydroxybiphenyl copolymer
26) 4-Hydroxybenzoic acid/terephthalic acid/4-aminophenol copolymer
27) 2-Hydroxy-6-naphthoic acid/terephthalic acid/4-aminophenol copolymer
28) 4-Hydroxybenzoic acid/2-hydroxy-6-naphthoic acid/terephthalic acid/4-aminophenol copolymer
29) 4-Hydroxybenzoic acid/terephthalic acid/4,4′-dihydroxybiphenyl/4-aminophenol copolymer
30) 4-Hydroxybenzoic acid/terephthalic acid/ethylene glycol copolymer
31) 4-Hydroxybenzoic acid/terephthalic acid/4,4′-dihydroxybiphenyl/ethylene glycol copolymer
32) 4-Hydroxybenzoic acid/2-hydroxy-6-naphthoic acid/terephthalic acid/ethylene glycol copolymer
33) 4-Hydroxybenzoic acid/2-hydroxy-6-naphthoic acid/terephthalic acid/4,4′-dihydroxybiphenyl/ethylene glycol copolymer
34) 4-Hydroxybenzoic acid/terephthalic acid/2,6-naphthalenedicarboxylic acid/4,4′-dihydroxybiphenyl copolymer.

The content of the structural unit (1) of the liquid crystalline polyester is preferably 30 mol % or more, more preferably 30 to 90 mol %, more preferably 30 to 85 mol %, even more preferably 40 to 75 mol %, and especially preferably 50 to 70 mol %, based on the total amount of all the structural units constituting the liquid crystalline polyester (the value of the sum of the amount of substance equivalent (mol) of each structural unit constituting the liquid crystalline polyester determined by dividing the mass of the structural unit by the formula mass of the structural unit).

When the content of the structural unit (1) of the liquid crystalline polyester is 30 mol % or more, the heat resistance and the hardness of a film obtained by using the liquid crystalline polyester composition of the present embodiment are easily improved. In addition, when the content of the structural unit (1) is 80 mol % or less, the melt viscosity can be lowered. Therefore, the temperature required for molding the liquid crystalline polyester is likely to be low.

The content of the structural unit (2) of the liquid crystalline polyester is preferably 35 mol % or less, more preferably 10 to 35 mol %, even more preferably 15 to 35 mol %, and especially preferably 17.5 to 32.5 mol %, based on the total amount of all the structural units constituting the liquid crystalline polyester.

The content of the structural unit (3) of the liquid crystalline polyester is preferably 35 mol % or less, more preferably 10 to 35 mol %, even more preferably 15 to 35 mol %, and especially preferably 17.5 to 32.5 mol %, based on the total amount of all the structural units constituting the liquid crystalline polyester.

In the liquid crystalline polyester, when the proportion of the content of the structural unit (3) to the content of the structural unit (2) is expressed as [content of structural unit (3)]/[content of structural unit (2)] (mol/mol), the molar ratio of the structural unit (3)/the structural unit (2) is preferably lees than 1, preferably 0.70 or more and less than 1, more preferably 0.75 or more and 0.95 or less, even more preferably 0.8 or more and 0.93 or less, especially preferably 0.81 or more and 0.90 or less, and particularly preferably 0.82 or more and 0.88 or less.

In the liquid crystalline polyester, the proportion of the content of the structural unit (3) to the content of the structural unit (1) is, when expressed as [content of structural unit (3)]/[content of structural unit (1)] (mol/mol), preferably 0.2 or more and 1.0 or less, more preferably 0.25 or more and 0.85 or less, and even more preferably 0.3 or more and 0.75 or less.

The liquid crystalline polyester may have only one kind of the structural units (1) to (3), each independently, or may have two or more kinds of them. In addition, the liquid crystalline polyester may have one or more than two structural units other than the structural units (1) to (3), and the content thereof is preferably 10 mol % or less, and more preferably 5 mol % or less, based on the total amount of all the structural units of the liquid crystalline polyester.

In the present embodiment, it is also possible to use a liquid crystalline polyester resin mixture in which a plurality of liquid crystalline polyesters are mixed.

Here, the liquid crystalline polyester resin mixture is a mixture of liquid crystalline polyester resins different from each other in flow starting temperature.

In the liquid crystalline polyester resin mixture, the liquid crystalline polyester resin having the highest flow starting temperature is referred to as a first liquid crystalline polyester resin, and the liquid crystalline polyester resin having the lowest flow starting temperature is referred to as a second liquid crystalline polyester resin. A liquid crystalline polyester resin mixture consisting substantially of the first liquid crystalline polyester and the second liquid crystalline polyester is preferable.

In addition, in the liquid crystalline polyester mixture, the content of the second liquid crystalline polyester is preferably 10 to 150 parts by mass, more preferably 30 to 120 parts by mass, and even more preferably 50 to 100 parts by mass, based on 100 parts by mass of the first liquid crystalline polyester.

The liquid crystalline polyester in the liquid crystalline polyester powder according to the embodiment has a flow starting temperature of preferably 263° C. or lower, more preferably 230° C. or higher and 261° C. or lower, even more preferably 240° C. or higher and 260° C. or lower, and particularly preferably 249° C. or higher and 254.5° C. or lower.

When the flow starting temperature of the liquid crystalline polyester in the liquid crystalline polyester powder is at or below the above upper limit value, the value of the temperature of the endothermic peak detected by differential scanning calorimetry of the liquid crystalline polyester is not too high even after undergoing solid phase polymerization, and it is easy to melt the liquid crystalline polyester and bond the liquid crystalline polyester film and another layer together.

Also, the higher the flow starting temperature of the liquid crystalline polyester, the easier it is to improve heat resistance, strength, and rigidity, but when it is too high, it becomes difficult to obtain a powder with the target particle diameter due to poor pulverizability.

The flow starting temperature, also called flow temperature or flowing temperature, is the temperature at which the liquid crystalline polyester exhibits a viscosity of 4800 Pa·s (48000 poises) when it is melted using a capillary rheometer under a load of 9.8 MPa (100 kg/cm²) while the temperature is increased at a rate of 4° C./min and extruded through a nozzle with an inner diameter of 1 mm and a length of 10 mm, and is a guide to the molecular weight of the liquid crystalline polyester (see “Synthesis, Molding, and Application of Liquid Crystal Polymer”, edited by Naoyuki Koide, CMC Publishing Co., Ltd., Jun. 5, 1987, p. 95).

The weight average molecular weight of the liquid crystalline polyester in the liquid crystalline polyester powder according to the embodiment, as measured using polystyrene as the reference material, is preferably 70000 or less, more preferably 20000 to 70000, even more preferably 30000 to 65000, and particularly preferably 40000 to 60000.

When the weight average molecular weight of the liquid crystalline polyester in the liquid crystalline polyester powder is at or below the above upper limit value, the value of the temperature of the endothermic peak detected by differential scanning calorimetry of the liquid crystalline polyester is not too high even after undergoing solid phase polymerization, and it is easy to melt the liquid crystalline polyester and bond the liquid crystalline polyester film and another layer together. Also, it is easy to process the liquid crystalline polyester into a film having excellent isotropy. The smaller the weight average molecular weight of the liquid crystalline polyester is, the better the thermal conductivity in the thickness direction of the film after heat-treatment tends to be, which is preferable, and when the number average molecular weight of the liquid crystalline polyester is at or above the above lower limit value, the heat resistance, strength, and rigidity of the film after heat-treatment are good.

The number average molecular weight of the liquid crystalline polyester in the liquid crystalline polyester powder according to the embodiment, as measured using polystyrene as the reference material, is preferably 30000 or less, more preferably 5000 to 30000, even more preferably 8000 to 20000, and particularly preferably 10000 to 15000.

When the number average molecular weight of the liquid crystalline polyester in the liquid crystalline polyester powder is at or below the above upper limit value, the value of the temperature of the endothermic peak detected by differential scanning calorimetry of the liquid crystalline polyester is not too high even after undergoing solid phase polymerization, and it is easy to melt the liquid crystalline polyester and bond the liquid crystalline polyester film and another layer together. Also, it is easy to process the liquid crystalline polyester into a film having excellent isotropy. The smaller the number average molecular weight of the liquid crystalline polyester is, the better the thermal conductivity in the thickness direction of the film after heat-treatment tends to be, which is preferable, and when the number average molecular weight of the liquid crystalline polyester is at or above the above lower limit value, the heat resistance, strength, and rigidity of the film after heat-treatment are good.

In the present description, the “weight average molecular weight” and the “number average molecular weight” mean the values that can be determined by gel permeation chromatography (GPC) analysis and are determined in terms of standard polystyrene based on a calibration curve obtained by measuring the molecular weight of standard polystyrene.

The temperature of the endothermic peak detected by differential scanning calorimetry of the liquid crystalline polyester in the liquid crystalline polyester powder according to the embodiment (endothermic peak temperature (A) before solid phase polymerization) is preferably 293° C. or lower, more preferably 250 to 292° C., even more preferably 260 to 291° C., and particularly preferably 270° C. or higher and 290° C. or lower.

The liquid crystalline polyester in the liquid crystalline polyester powder of the embodiment is unlikely to cause the temperature increase in the endothermic peak even after undergoing solid phase polymerization. Therefore, when the value of the endothermic peak temperature (A) of the liquid crystalline polyester in the liquid crystalline polyester powder is at or below the above upper limit value, even if a liquid crystalline polyester film is obtained through solid phase polymerization, melting of the liquid crystalline polyester in the film is easy. For example, it is easy to melt the liquid crystalline polyester and bond the liquid crystalline polyester film and another layer together by the lamination method or other methods.

The temperature of the endothermic peak of the liquid crystalline polyester can be measured as the temperature (° C.) at the apex position of the endothermic peak due to melting of the liquid crystalline polyester, obtained by increasing the temperature from room temperature (23° C.) at a rate of 10° C./min using a differential scanning calorimeter (for example, “DSC-60A Plus” from Shimadzu Corporation).

The liquid crystalline polyester in the liquid crystalline polyester powder according to the embodiment has the excellent property that the temperature increase in the endothermic peak detected by differential scanning calorimetry of the liquid crystalline polyester is unlikely to occur even after undergoing solid phase polymerization.

The value of the temperature increase, (B)−(A), from the temperature of the endothermic peak (A) of the liquid crystalline polyester before solid phase polymerization to the temperature of the endothermic peak (B) of the liquid crystalline polyester after solid phase polymerization in the liquid crystalline polyester powder is preferably 20° C. or less, more preferably 3 to 15° C., even more preferably 4 to 12° C., and particularly preferably 5 to 9° C. The solid phase polymerization here shall be carried out under a nitrogen atmosphere by a heat-treatment in which the temperature is increased from room temperature (23° C.) to 310° C. over 4 hours and is held at 310° C. for 2 hours.

### (Method for Producing Liquid Crystalline Polyester)

Next, an example of a method for producing the liquid crystalline polyester according to the present embodiment will be described. Examples of the liquid crystalline polyester include those given above as examples, and a polymer obtained by condensation polymerization (polycondensation) of an aromatic hydroxycarboxylic acid, an aromatic dicarboxylic acid, and an aromatic diol is preferable.

A method for producing the liquid crystalline polyester powder in the liquid crystalline polyester powder of the embodiment comprises a step of obtaining the liquid crystalline polyester by using the aromatic diol and the aromatic dicarboxylic acid as monomers, and
the molar ratio of the aromatic diol/the aromatic dicarboxylic acid is less than 1, preferably 0.95 or less, more preferably 0.93 or less, even more preferably 0.90 or less, and particularly preferably 0.88 or less.

In the method for producing the liquid crystalline polyester of the embodiment, the lower limit value of the molar ratio of the aromatic diol/the aromatic dicarboxylic acid may be 0.70 or more, may be 0.75 or more, may be 0.8 or more, may be 0.81 or more, or may be 0.82 or more, from the viewpoint of making production of the liquid crystalline polyester more efficient.

In the method for producing the liquid crystalline polyester of the embodiment, an example of the above numerical range of the molar ratio of the aromatic diol/the aromatic dicarboxylic acid may be 0.70 or more and less than 1, may be 0.75 or more and 0.95 or less, may be 0.8 or more and 0.93 or less, may be 0.81 or more and 0.90 or less, or may be 0.82 or more and 0.88 or less.

In the case where multiple types of aromatic diols are used in the method for producing the liquid crystalline polyester, the amount of substance of the aromatic diol in the above molar ratio is the sum of the amount of substance of the multiple types of aromatic diols.

Similarly, in the case where multiple types of aromatic dicarboxylic acids are used in the method for producing the liquid crystalline polyester, the amount of substance of the aromatic dicarboxylic acid in the above molar ratio is the sum of the amount of substance of the multiple types of aromatic diols.

The amount of the aromatic diol and aromatic dicarboxylic acid used in the method for producing the liquid crystalline polyester of the embodiment is preferably 20 to 100 mol %, more preferably 30 to 80 mol %, and even more preferably 40 to 60 mol %, based on 100 mol % of the total amount of all monomers used in polymerization of the liquid crystalline polyester.

According to the method for producing the liquid crystalline polyester of the present embodiment, it is possible to produce the liquid crystalline polyester that is unlikely to cause a temperature increase in the endothermic peak detected by differential scanning calorimetry even after undergoing solid phase polymerization, contained in the above liquid crystalline polyester powder of the embodiment.

The reason for this is presumably because, by setting the molar ratio of the aromatic diol/the aromatic dicarboxylic acid used as monomers to the above upper limit value or less, a balance between the equivalent amounts of functional groups of the polymerizable combination derived from the aromatic diol and aromatic dicarboxylic acid that remain at terminals of the main chain of the liquid crystalline polyester is disrupted, and in the case where the liquid crystalline polyester then undergoes solid phase polymerization, the polymerization reaction of the liquid crystalline polyester can be made difficult to proceed.

Even when a balance between the equivalent amounts of functional groups of the polymerizable combination is disrupted, it is possible to allow the polymerization reaction of the liquid crystalline polyester itself to progress to some extent until the stage where the reaction partner becomes scarce and the reaction efficiency declines. Therefore, basically, all of the polymerizable monomers used in the polymerization reaction of the liquid crystalline polyester can be considered to be incorporated into the skeleton of the liquid crystalline polyester. That is, the molar ratio between the charged monomers (the aromatic diol and the aromatic dicarboxylic acid) used in the polymerization reaction and the molar ratio between the structural units (the structural units derived from the aromatic diol and the aromatic dicarboxylic acid) may be considered to be the same.

The concept of monomers used in the method for producing the liquid crystalline polyester encompasses polymerizable derivatives of the monomers. For example, the aromatic diol specified as described above may be an acylated product of the aromatic diol.

The liquid crystalline polyester of the present embodiment is preferably produced by the following acylation step and polymerization step using monomers of the liquid crystalline polyester to be produced.

The acylation step is a step of obtaining an acylated product by acylating a phenolic hydroxyl group contained in a raw material monomer with a fatty acid anhydride (for example, acetic anhydride).

In the polymerization step, a liquid crystalline polyester may be obtained by polymerizing an acyl group of the acylated product obtained in the acylation step and carboxy groups of acylated products of an aromatic dicarboxylic acid and an aromatic hydroxycarboxylic acid in such a way as to cause ester exchange.

The acylation step and the polymerization step may be carried out in the presence of a heterocyclic organic base compound represented by the following formula (5).

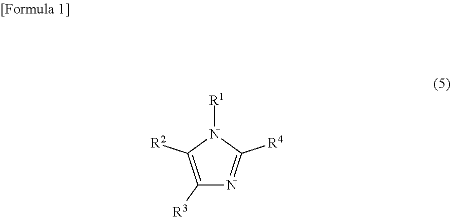

In the above formula (5), R¹ to R⁴ each independently represent a hydrogen atom, an alkyl group having 1 to 4 carbon atoms, a hydroxymethyl group, a cyano group, and a cyanoalkyl group having an alkyl group having 1 to 4 carbon atoms, a cyanoalkoxy group having an alkoxy group having 1 to 4 carbon atoms, a carboxy group, an amino group, an aminoalkyl group having 1 to 4 carbon atoms, an aminoalkoxy group having 1 to 4 carbon atoms, a phenyl group, a benzyl group, a phenylpropyl group, or a formyl group.

The heterocyclic organic base compound of the above formula (5) is preferably an imidazole derivative in which R¹ is an alkyl group having 1 to 4 carbon atoms and R² to R⁴ are each a hydrogen atom. Thereby, the reactivity of the acylation reaction in the acylation step and the ester exchange reaction in the polymerization step can be further improved. In addition, the color tone of the liquid crystalline polyester film obtained by using the liquid crystalline polyester composition of the present embodiment can be further improved.

Among the heterocyclic organic base compounds, one or both of 1-methylimidazole and 1-ethylimidazole is particularly preferable because these are easily available.

In addition, the amount of the heterocyclic organic base compound used is preferably 0.005 to 1 part by mass when the total amount of the raw material monomers of the liquid crystalline polyester (that is, an aromatic dicarboxylic acid, an aromatic diol, and an aromatic hydroxycarboxylic acid) is 100 parts by mass. In addition, from the viewpoint of the color tone and the productivity of the molded product, the amount of the heterocyclic organic base compound used is more preferably 0.05 to 0.5 parts by mass based on 100 parts by mass of the raw material monomers.

The heterocyclic organic basic compound may be present for a period of time during the acylation reaction and the ester exchange reaction, and the time of addition thereof may be immediately before the start of the acylation reaction or in the middle of the acylation reaction or between the acylation reaction and the ester exchange reaction. The liquid crystalline polyester thus obtained has very high melt flowability and excellent thermal stability.

The amount of the fatty acid anhydride (for example, acetic anhydride) used should be determined in consideration of the amount of the aromatic diol and the aromatic hydroxycarboxylic acid used as raw material monomers. Specifically, based on the total equivalents of the phenolic hydroxyl groups included in these raw material monomers, the amount of the fatty acid anhydride used is preferably 1.0 times equivalents or more and 1.2 times equivalents or less, and more preferably 1.03 times equivalents or more and 1.15 times equivalents or less.

When the amount of the fatty acid anhydride used is 1.0 times equivalents or more based on the total equivalents of the phenolic hydroxyl groups included in the raw material monomers, the acylation reaction is likely to proceed, and the unreacted raw material monomers are unlikely to remain in the subsequent polymerization step, and as a result, the polymerization proceeds efficiently. In addition, when the acylation reaction proceeds sufficiently as described above, there is little possibility that the unacylated raw material monomers sublimate and the fractionator used at the time of the polymerization is clogged. On the other hand, when the amount of the fatty acid anhydride used is 1.2 times equivalents or less, the liquid crystalline polyester obtained is unlikely to be colored.

The acylation reaction in the above acylation step is preferably carried out in the temperature range between 130° C. and 180° C. for 30 minutes to 20 hours, and more preferably carried out between 140° C. and 160° C. for 1 to 5 hours.

The aromatic dicarboxylic acid that can be used in the above polymerization step may be present in the reaction system during the acylation step. That is, in the acylation step, the aromatic diol, the aromatic hydroxycarboxylic acid, and the aromatic dicarboxylic acid may be present in the same reaction system. This is because neither the carboxy group nor the substituent optionally substituted in the aromatic dicarboxylic acid is affected by the fatty acid anhydride.

Therefore, a method of charging the aromatic diol, the aromatic hydroxycarboxylic acid, and the aromatic dicarboxylic acid into a reactor and then sequentially carrying out the acylation step and the polymerization step may be used, or a method of charging the aromatic diol and the aromatic dicarboxylic acid into a reactor to carry out the acylation step and then even more charging the aromatic dicarboxylic acid into the reactor to carry out the polymerization step may be used. The former method is preferable from the viewpoint of simplifying the production step.

The ester exchange reaction in the above polymerization step is preferably carried out while raising the temperature from 130° C. to 400° C. at a temperature increase rate between 0.1 and 50° C./min, and even more preferably carried out while raising the temperature from 150° C. to 350° C. at a temperature increase rate between 0.3 and 5° C./min.

In addition, when carrying out the ester exchange reaction in the polymerization step, in order to shift the equilibrium, a fatty acid (for example, acetic acid) generated as a by-product and the unreacted fatty acid anhydride (for example, acetic anhydride) are preferably evaporated and distilled out of the system. At this time, by refluxing a part of the distilled fatty acid back to the reactor, the raw material monomers or the like that evaporate or sublimate together with the fatty acid can also be condensed or reverse sublimated back to the reactor.

In the acylation reaction in the acylation step and the ester exchange reaction in the polymerization step, a batch apparatus may be used or a continuous apparatus may be used as the reactor. A liquid crystalline polyester that can be used in the present embodiment can be obtained even by using any of the reaction apparatuses.

By performing pulverization after the above polymerization step, the target liquid crystalline polyester powder can be obtained. Although it is also possible to increase the molecular weight of the liquid crystalline polyester obtained in the polymerization step by carrying out a heat-treatment such as solid phase polymerization after the polymerization step, it is desirable not to carry out a step of increasing the molecular weight such as solid phase polymerization for the liquid crystalline polyester contained in the liquid crystalline polyester powder, in consideration of the pulverizability of the liquid crystalline polyester before pulverization.

The liquid crystalline polyester having the suitable flow starting temperature described above can be easily obtained by appropriately optimizing the structural units constituting the liquid crystalline polyester. That is, if the linearity of the molecular chain of the liquid crystalline polyester is improved, the flow starting temperature thereof tends to increase.

For example, the structural unit derived from terephthalic acid improves the linearity of the liquid crystalline polyester molecular chain. On the other hand, the structural unit derived from isophthalic acid improves the flexibility (lowers the linearity) of the liquid crystalline polyester molecular chain. Therefore, by controlling a copolymerization ratio of terephthalic acid and isophthalic acid, a liquid crystalline polyester having a desired flow starting temperature can be obtained.

When the above liquid crystalline polyester mixture is used, at least one liquid crystalline polyester is preferably a polymer obtained by polymerizing raw material monomers comprising an aromatic hydroxycarboxylic acid in the presence of an imidazole compound. The liquid crystalline polyester thus obtained has very high flowability at the time of melting and excellent thermal stability.

Also, in the liquid crystalline polyester used in the present embodiment, it is preferable to optimize the copolymerization ratio of terephthalic acid and isophthalic acid. Thereby, the linearity of the molecular chain of the liquid crystalline polyester can be controlled, as described above. As a result, multiple types of liquid crystalline polyesters with different flow starting temperatures can each be produced.

### (Liquid Crystalline Polyester Powder)

The average particle diameter (D₅₀) of the liquid crystalline polyester powder is preferably 30 μm or less, preferably 20 μm or less, more preferably 18 μm or less, even more preferably 15 μm or less, and particularly preferably 10 μm or less. When the average particle diameter of the liquid crystalline polyester powder is greater than 30 μm, it becomes difficult to obtain a liquid crystalline polyester composition in which the dispersion state of the liquid crystalline polyester powder is good. Also, when the average particle diameter of the liquid crystalline polyester is 20 μm or less, it is possible to produce a liquid crystalline polyester film with good smoothness of the film surface at a thickness suitable as a film for electronic components (for example, 50 μm or less).

From the viewpoint of ease of handling the powder, the average particle diameter (D₅₀) of the liquid crystalline polyester powder is preferably 0.5 μm or more, more preferably 3 μm or more, and even more preferably 5 μm or more.

The above upper limit values and lower limit values of the average particle diameter (D₅₀) of the liquid crystalline polyester powder can be freely combined. An example of the numerical range of the value of the average particle diameter of the liquid crystalline polyester powder described above may be 0.5 μm or more and 30 μm or less, may be 0.5 μm or more and 20 μm or less, may be 3 μm or more and 18 μm or less, may be 5 μm or more and 15 μm or less, may be 5 μm or more and 12 μm or less, or may be 5 μm or more and 10 μm or less.

The particle diameter (D₁₀) of the liquid crystalline polyester powder is preferably 1 μm or more and 20 μm or less, more preferably 2 μm or more and 18 μm or less, and even more preferably 3 μm or more and 15 μm or less. A liquid crystalline polyester powder with a D₁₀ value within the above range is preferable because dispersibility in a medium is improved.

The particle diameter (D₉₀) of the liquid crystalline polyester powder is preferably 5 μm or more and 100 μm or less, more preferably 10 μm or more and 80 μm or less, and even more preferably 15 μm or more and 60 μm or less.

A liquid crystalline polyester powder with a D₉₀ value within the above range is preferable because dispersibility in a medium is improved.

In the present description, the “average particle diameter” is the value of the particle diameter at the point where the cumulative volume is 50% (50% cumulative volume particle size D₅₀) when the whole is defined as 100% in a volume-based cumulative particle size distribution curve measured by the laser diffraction scattering method.

Also, the particle diameters at which the cumulative volume proportion from the small particle side is 10% and 90% are defined as D₁₀ and D₉₀, respectively.

The liquid crystalline polyester composition of the embodiment described later may be a dispersion wherein a liquid crystalline polyester powder is insoluble in a medium and the liquid crystalline polyester powder is dispersed in the medium that is a liquid.

Here, whether the liquid crystalline polyester powder is insoluble in the medium can be confirmed by carrying out the following test.

### Test Method

A liquid crystalline polyester powder (5 parts by mass) is stirred in a medium (95 parts by mass) at a temperature of 180° C. using an anchor blade under a stirring condition of 200 rpm for 6 hours, and then cooled to room temperature (23° C.). Next, filtration is carried out using a membrane filter having the aperture size of 5 μm and a pressurized filtration machine, and then a residue on the membrane filter is checked. At this time, when no solid is found, it is determined that the liquid crystalline polyester is soluble in the medium. When solid is found, it is determined that the liquid crystalline polyester is insoluble in the medium. The solid can be observed by microscopic observation. When the liquid crystalline polyester powder is insoluble in the medium, it is not necessary to dissolve the liquid crystalline polyester powder in the solvent in each of the methods for producing a liquid crystalline polyester film or a laminate according to the embodiment described later, and thus the liquid crystalline polyester having excellent dielectric properties, such as those exemplified as having the structural units (1) to (3), can be adopted as a raw material. A liquid crystalline polyester film having excellent dielectric properties can be produced from the liquid crystalline polyester powder having excellent dielectric properties.

In the present description, the “dielectric properties” refer to properties relating to the relative permittivity and the dielectric loss tangent.

The liquid crystalline polyester powder according to the embodiment preferably has a relative permittivity at a frequency of 1 GHz of 3 or less, preferably 2.9 or less, preferably 2.8 or less, more preferably less than 2.8, even more preferably 2.78 or less, and particularly preferably 2.76 or less. In addition, the relative permittivity of the liquid crystalline polyester powder may be 2.5 or more, 2.6 or more, or 2.7 or more.

The above upper limit values and the above lower limit values of a value of the relative permittivity of the liquid crystalline polyester powder can be freely combined. An example of the numerical range of a value of the relative permittivity of the liquid crystalline polyester powder may be 2.5 or more and 3 or less, 2.6 or more and 2.78 or less, or 2.7 or more and 2.76 or less.

The liquid crystalline polyester powder according to the embodiment preferably has a dielectric loss tangent at a frequency of 1 GHz of 0.005 or less, preferably 0.004 or less, more preferably 0.003 or less, even more preferably 0.0025 or less, and particularly preferably 0.002 or less. In addition, the dielectric loss tangent of the liquid crystalline polyester powder may be 0.0003 or more, 0.0005 or more, or 0.001 or more.

An example of the numerical range of a value of the dielectric loss tangent of the liquid crystalline polyester powder may be 0.0003 or more and 0.005 or less, 0.0005 or more and 0.004 or less, 0.001 or more and 0.003 or more, 0.001 or more and 0.0025 or less, and 0.001 or more and 0.002 or less.

The relative permittivity and the dielectric loss tangent at a frequency of 1 GHz of the liquid crystalline polyester powder can be measured under the following conditions by a capacitance method using an impedance analyzer.

A liquid crystalline polyester fine particle powder is melted at a temperature of 5° C. higher than the flow starting temperature measured using a flow tester, and then cooled and solidified to manufacture a tablet having a diameter of 1 cm and a thickness of 0.5 cm. The relative permittivity and the dielectric loss tangent at 1 GHz are measured under the following conditions for the obtained tablet.
Measurement method: Capacitance method
Electrode model: 16453A
Measurement environment: 23° C., 50% RH
Applied voltage: 1 V

The relative permittivity and the dielectric loss tangent of the liquid crystalline polyester powder according to the embodiment may be different from those of the liquid crystalline polyester film produced from the powder as a raw material. It is considered that the difference is because of the difference between the molecular weight of the liquid crystalline polyester contained in the powder and that in the film.

The proportion of content of the liquid crystalline polyester may be 80 to 100% by mass or may be 90 to 98% by mass, based on 100% by mass of the liquid crystalline polyester powder according to the embodiment.

The proportion of content of the liquid crystalline polyester having a structural unit derived from an aromatic diol and a structural unit derived from an aromatic dicarboxylic acid, wherein the molar ratio of the structural unit derived from an aromatic diol/the structural unit derived from an aromatic dicarboxylic acid is less than 1, may be 80 to 100% by mass or may be 90 to 98% by mass, based on 100% by mass of the liquid crystalline polyester powder according to the embodiment.

Also, although acetic acid derived from acetic anhydride, which may be used for production of the liquid crystalline polyester, may remain in the liquid crystalline polyester powder according to the embodiment, the amount of remaining acetic acid that may be included in 100% by mass of the liquid crystalline polyester powder according to the embodiment is preferably 1% by mass or less from the viewpoint of mechanical properties after processing into a film, more preferably 500 ppm by mass or less, and even more preferably 300 ppm by mass or less. In addition, the amount of remaining acetic acid included in 100% by mass of the liquid crystalline polyester powder according to the embodiment is preferably 30 ppm by mass or more from the viewpoint of pulverizability, more preferably 50 ppm by mass or more, and even more preferably 100 ppm by mass or more.

An example of the numerical range of the value of the amount of remaining acetic acid that may be included in 100% by mass of the liquid crystalline polyester powder described above may be 30 ppm by mass or more and 1% by mass or less, may be 50 ppm by mass or more and 500 ppm by mass or less, or may be 100 ppm by mass or more and 300 ppm by mass or less.

### <<Method for Producing Liquid Crystalline Polyester Powder>>

The liquid crystalline polyester powder according to the embodiment can be obtained by, for example, performing a pulverization treatment using a jet mill or the like, if necessary, on a liquid crystalline polyester produced by the above method for producing the liquid crystalline polyester.

The method for controlling the particle diameter in the above range is, for example, a method in which the liquid crystalline polyester is crushed using a jet mill.

In this case, the particle diameter can be controlled by changing the rotation speed of a classifying rotor, the pulverization nozzle pressure, the treatment speed, or the like. In addition, the operation of particle classification may be carried out using a sieve having an aperture size corresponding to the desired particle diameter.

By including a step of obtaining the liquid crystalline polyester using the aromatic diol and the aromatic dicarboxylic acid as monomers and by setting the molar ratio of the aromatic diol/the aromatic dicarboxylic acid to less than 1, as described above as the method for producing the liquid crystalline polyester, the liquid crystalline polyester powder according to one embodiment of the present invention can be easily obtained.

In the method for producing the liquid crystalline polyester powder of the embodiment, an example of the numerical range of the molar ratio of the aromatic diol/the aromatic dicarboxylic acid may be 0.70 or more and less than 1, may be 0.75 or more and 0.95 or less, may be 0.8 or more and 0.93 or less, may be 0.81 or more and 0.90 or less, or may be 0.82 or more and 0.88 or less.

According to the method for producing the polyester powder of the embodiment, the above liquid crystalline polyester powder of the embodiment can be produced.

### <<Liquid Crystalline Polyester Composition>>

The liquid crystalline polyester composition of the embodiment is a composition that comprises a medium and the liquid crystalline polyester powder of the embodiment.

### <Medium>

The medium included in the liquid crystalline polyester composition of the embodiment is preferably a substance that is in a liquid state at 1 atm (1013.25 hPa) and 25° C. The medium is preferably a volatile component that is a substance that can be volatilized during the producing of a liquid crystalline polyester film.

The medium is preferably a dispersion medium in which a liquid crystalline polyester powder is insoluble, and which disperses a liquid crystalline polyester powder.

The liquid crystalline polyester composition of the embodiment is preferably a dispersion wherein the liquid crystalline polyester powder is insoluble in the medium and the liquid crystalline polyester powder is dispersed in the medium that is a liquid.

The “dispersion” here refers to a state in which the liquid crystalline polyester powder floats or is suspended in the dispersion medium, and is a term used to distinguish the above state from a state in which the liquid crystalline polyester powder is dissolved (to except for a state in which the liquid crystalline polyester powder is completely dissolved in the liquid crystalline polyester composition). The distribution of the liquid crystalline polyester powder in the composition may have a non-uniform part. The state of the liquid crystalline polyester powder in the composition may be a state in which the liquid crystalline polyester composition can be applied onto a support in the method for producing a liquid crystalline polyester film described later.

Examples of the medium include an aliphatic polyhydric alcohol such as glycerin, neopentyl glycol, ethylene glycol, propylene glycol, butanediol, hexylene glycol, polyethylene glycol, or polypropylene glycol; a halogenated hydrocarbon such as dichloromethane, chloroform, 1,1-dichloroethane, 1,2-dichloroethane, 1,1,2,2-tetrachloroethane, 1-chlorobutane, chlorobenzene, or o-dichlorobenzene; a halogenated phenol such as p-chlorophenol, pentachlorophenol, or pentafluorophenol; an ether such as diethyl ether, di-(2-chloroethyl)ether, tetrahydrofuran, or 1,4-dioxane; a ketone such as acetone, cyclohexanone, or isophorone; an ester such as ethyl acetate, butyl lactate, and γ-butyrolactone; a carbonate such as ethylene carbonate or propylene carbonate; an amine such as triethylamine; a nitrogen-containing heterocyclic aromatic compound such as pyridine; a nitrile such as acetonitrile or succinonitrile; an amide such as N,N-dimethylformamide, N,N-dimethylacetamide, or N-methylpyrrolidone, a urea compound such as tetramethylurea; a nitro compound such as nitromethane or nitrobenzene; a sulfur compound such as dimethylsulfoxide or sulfolane; and a phosphorus compound such as hexamethylphosphoramide or tri n-butyl phosphate, and two or more of these may be used.

The medium may be an aprotic solvent. The aprotic solvent is a solvent comprising an aprotic compound. Examples of the aprotic solvent include a halogen-based solvent such as 1-chlorobutane, chlorobenzene, 1,1-dichloroethane, 1,2-dichloroethane, chloroform, or 1,1,2,2-tetrachloroethane, an ether-based solvent such as diethyl ether, tetrahydrofuran, or 1,4-dioxane, a ketone-based solvent such as acetone or cyclohexanone, an ester-based solvent such as ethyl acetate, a lactone-based solvent such as γ-butyrolactone, a carbonate-based solvent such as ethylene carbonate or propylene carbonate, an amine-based solvent such as triethylamine or pyridine, a nitrile-based solvent such as acetonitrile or succinonitrile, an amide-based solvent such as N,N-dimethylformamide, N,N-dimethylacetamide, tetramethylurea, or N-methylpyrrolidone, a nitro-based solvent such as nitromethane or nitrobenzene, a sulfide-based solvent such as dimethylsulfoxide or sulfolane, and a phosphoric acid-based solvent such as hexamethylphosphoramide or tri n-butyl phosphate.

The liquid crystalline polyester composition of the embodiment may comprise a medium having a specific gravity of 0.90 or more as a medium having excellent dispersibility of the liquid crystalline polyester powder.

In the present description, the “specific gravity” of a medium is one determined as measured in accordance with (Hydrometer) of JIS Z 8804:2012 using water as the reference substance. The specific gravity here is defined as the density of a sample liquid divided by the density of water under a pressure of 101325 Pa (1 atm).

The liquid crystalline polyester composition of the embodiment comprises a medium having a specific gravity of 0.90 or more, preferably comprises a medium having a specific gravity of 0.95 or more, more preferably comprises a medium having a specific gravity of 1.03 or more, even more preferably comprises a medium having a specific gravity of 1.1 or more, and particularly preferably comprises a medium having a specific gravity of 1.3 or more. When the specific gravity of the medium is equal to or greater than the above lower limit value, the dispersibility of the liquid crystalline polyester powder is excellent.

The upper limit value of the specific gravity may be 1.84 or less as an example. The liquid crystalline polyester composition of the embodiment may comprise a medium having a specific density of 1.84 or less, a medium having a specific gravity of 1.68 or less, a medium having a specific gravity of 1.58 or less, or a medium having a specific gravity of 1.48 or less.

When the specific gravity of the medium is equal to or less than the above upper limit value, the liquid crystalline polyester powder is prevented from floating on the liquid surface of the medium and becoming difficult to disperse.

The above upper limit values and the above lower limit values of a value of the specific gravity of the medium can be freely combined. As an example of the numerical range of a value of the specific gravity of the above medium, the liquid crystalline polyester composition of the embodiment may comprise a medium having a specific gravity of 0.90 or more and 1.84 or less, a medium having a specific gravity of 0.95 or more and 1.68 or less, a medium having a specific gravity of 1.03 or more and 1.58 or less, or a medium having a specific gravity of 1.1 or more and 1.48 or less.

The specific gravity of the liquid crystalline polyester powder according to the embodiment, as measured by JIS K 7112 (method A), can be 1.35 or more and 1.40 or less, for example.

The proportion of the content of the liquid crystalline polyester powder is preferably 1 to 40% by mass, more preferably 5 to 30% by mass, and even more preferably 7 to 20% by mass based on the total mass of the liquid crystalline polyester composition of the embodiment.

The proportion of the content of the medium based on the total mass of the liquid crystalline polyester composition of the embodiment is preferably 50 to 99% by mass, more preferably 60 to 95% by mass, and even more preferably 70 to 90% by mass.

The liquid crystalline polyester composition of one embodiment preferably contains 1 to 40% by mass of the liquid crystalline polyester powder and 50 to 99% by mass of the medium, based on the total mass of the liquid crystalline polyester composition.

The liquid crystalline polyester composition may comprise, in addition to the medium and the liquid crystalline polyester powder, if necessary, one or more other components such as a filler, an additive, and a resin that does not correspond to the liquid crystalline polyester powder so that the total content (% by mass) may not exceed 100% by mass.

Examples of the filler include an inorganic filler such as silica, alumina, titanium oxide, barium titanate, strontium titanate, aluminum hydroxide, or calcium carbonate; and an organic filler such as cured epoxy resin, crosslinked benzoguanamine resin, or crosslinked acrylic resin, and the content thereof may be 0 based on 100 parts by mass of the liquid crystalline polyester and is preferably 100 parts by mass or less.

Examples of the additive include a leveling agent, an antifoaming agent, an antioxidant, an ultraviolet absorbing agent, a flame retardant, and a colorant, and the content thereof may be 0 based on 100 parts by mass of the liquid crystalline polyester and is preferably 5 parts by mass or less.

Examples of the resin other than the liquid crystalline polyester include polypropylene, polyamide, a polyester other than the liquid crystalline polyester, a liquid crystalline polyester that does not correspond to the liquid crystalline polyester contained in the liquid crystalline polyester powder, polyphenylene sulfide, polyether ketone, poly carbonate, polyether sulfone, polyphenylene ether and a modified product thereof, a thermoplastic resin other than the liquid crystalline polyester such as polyetherimide; an elastomer such as a copolymer of glycidyl methacrylate and polyethylene; and a thermosetting resin such as a phenol resin, an epoxy resin, a polyimide resin, or a cyanate resin. A fluororesin can also be a preferable example of such other resin. The “fluororesin” means a resin containing a fluorine atom in its molecule, and examples thereof include a polymer having a structural unit containing a fluorine atom. The content of such other resin may be 0, and is preferably 20 parts by mass or less based on 100 parts by mass of the liquid crystalline polyester powder. Such other resin is preferably soluble in the medium.

### (Method for Producing Liquid Crystalline Polyester Composition)

The liquid crystalline polyester composition of the embodiment can be obtained by mixing a medium, a liquid crystalline polyester powder, and another component used as necessary in a batch or in an appropriate order.

As the medium and liquid crystalline polyester powder, those described in the above <<Liquid crystalline polyester composition>> can be given as examples.

One embodiment provides a method for producing the liquid crystalline polyester composition, the method comprising a step of mixing a liquid crystalline polyester powder comprising a liquid crystalline polyester having a structural unit derived from an aromatic diol and a structural unit derived from an aromatic dicarboxylic acid, wherein the molar ratio of the structural unit derived from an aromatic diol/the structural unit derived from an aromatic dicarboxylic acid in the liquid crystalline polyester is less than 1, and a medium.

### <<Method for Producing Liquid Crystalline Polyester Film>>

The method for producing the liquid crystalline polyester film of the embodiment comprises obtaining a liquid crystalline polyester film comprising a liquid crystalline polyester by applying the liquid crystalline polyester composition according to the embodiment onto a first support and heat-treating the liquid crystalline polyester composition.

As the liquid crystalline polyester composition, those described in the above <<Liquid crystalline polyester composition>> can be given as examples.

The method for producing a liquid crystalline polyester film may comprise the following steps.

A step of applying the liquid crystalline polyester composition according to the embodiment onto a first support to form a liquid crystalline polyester film precursor on the first support (application step).

A step of heat-treating the liquid crystalline polyester film precursor to obtain a liquid crystalline polyester film (heat-treatment step).

The application step in the method for producing a liquid crystalline polyester film may comprise, after applying the liquid crystalline polyester composition according to the embodiment onto a first support, a step of removing the medium from the applied liquid crystalline polyester composition (drying step).

That is, the method for producing a liquid crystalline polyester film according to the embodiment may comprise obtaining a liquid crystalline polyester film comprising a liquid crystalline polyester by applying the liquid crystalline polyester composition according to the embodiment onto a first support, removing the medium from the applied liquid crystalline polyester composition, and heat-treating the liquid crystalline polyester composition.

The heat-treatment preferably includes carrying out the polymerization reaction (solid phase polymerization) of the liquid crystalline polyester included in the liquid crystalline polyester film precursor.

Through the heat-treatment step, the liquid crystalline polyester powder can be melted to form a film, and also by carrying out solid phase polymerization of the liquid crystalline polyester, the liquid crystalline polyester can be polymerized to the desired molecular weight. In this way, the liquid crystalline polyester film can be obtained as a first laminate comprising the first support and the liquid crystalline polyester film.

In addition, the method for producing a liquid crystalline polyester film may even more comprise a step of separating the first support from a first laminate in which the first support and the liquid crystalline polyester film are laminated (separation step). However, the liquid crystalline polyester film can be suitably used as a film for an electronic part even in a state of being formed on the first support as a first laminate, and thus the separation step is not a necessary step in the production step of the liquid crystalline polyester film.

Hereinafter, an example of the method for producing a liquid crystalline polyester film according to the embodiment will be described with reference to drawings.

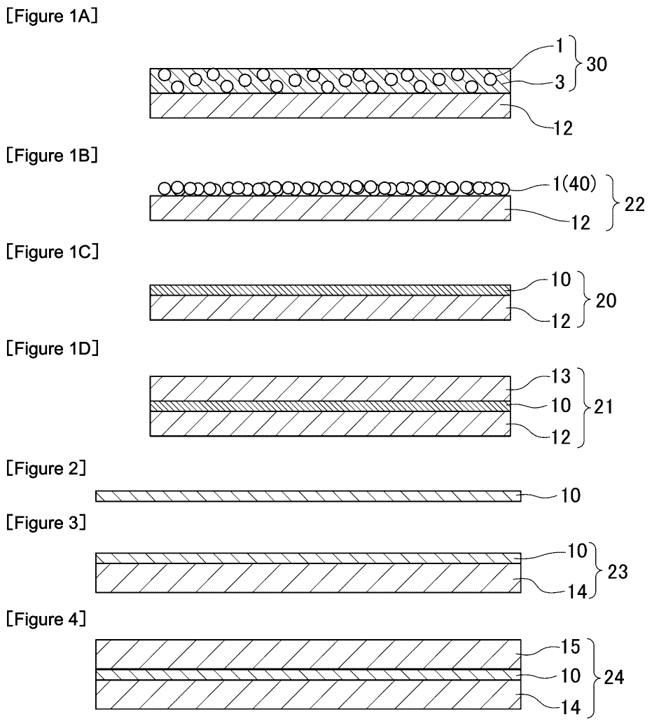

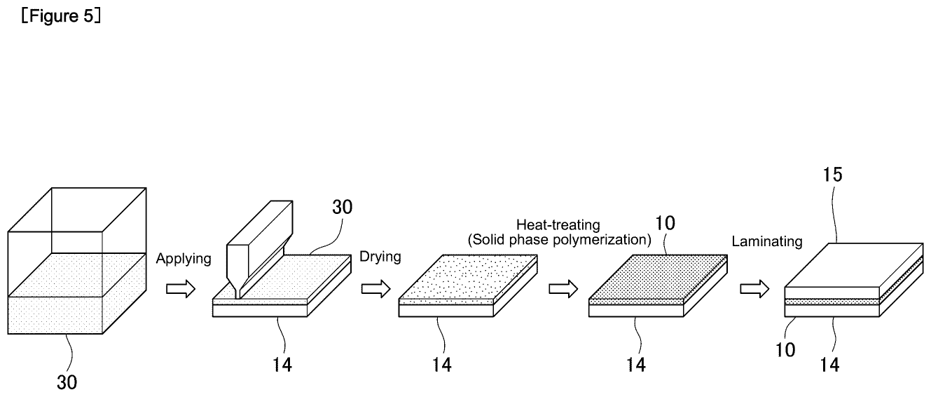

FIGS. 1A to 1D are schematic diagrams showing an example of a production process of the liquid crystalline polyester film, the first laminate and the second laminate according to the embodiment.

First, a liquid crystalline polyester composition 30 is applied onto a first support 12 (application step in FIG. 1A). The liquid crystalline polyester composition 30 comprises a liquid crystalline polyester powder 1 and a medium 3. A liquid crystalline polyester composition can be applied onto the first support by a roller coating method, a dip coating method, a spray coating method, a spinner coating method, a curtain coating method, a slot coating method, a screen printing method, or the like, and a method that enables application onto the first support in such a way as to provide smoothness and uniformity on the surface can be appropriately selected. In addition, in order to make the distribution of the liquid crystalline polyester powder uniform, the operation of stirring the liquid crystalline polyester composition may be carried out before application.

The first support 12 is preferably in the shape of a plate, a sheet, or a film, and examples thereof include a glass plate, a resin film, or a metal foil. Among these, a resin film or a metal foil is preferable, and a copper foil is particularly preferable because the copper foil has excellent heat resistance, it is easy to apply the liquid crystalline polyester composition onto the copper foil, and it is easy to remove the copper foil from the liquid crystalline polyester film.

Examples of the resin film include a polyimide (PI) film. Examples of a commercially available product thereof include “Upilex S” and “Upilex R” from UBE Corporation, “Kapton” from DuPont-Toray Co., Ltd., and “IF30,” “IF70,” and “LV300” from SKC Kolon PI, Inc. The thickness of the resin film is preferably 25 μm or more and 75 μm or less, and more preferably 50 μm or more and 75 μm or less. The thickness of the metal foil is preferably 3 μm or more and 75 μm or less, more preferably 5 μm or more and 30 μm or less, and even more preferably 10 μm or more and 25 μm or less.

Next, the medium 3 is removed from the liquid crystalline polyester composition 30 applied onto the first support 12 (FIG. 1B drying step) to obtain a liquid crystalline polyester film precursor 40 to be heat-treated. The medium 3 does not have to be completely removed from the liquid crystalline polyester composition, and a part of the medium included in the liquid crystalline polyester composition may be removed, or the entire medium may be removed. The proportion of the medium included in the liquid crystalline polyester film precursor 40 is preferably 50% by mass or less, more preferably 3% by mass or more and 12% by mass or less, and even more preferably 5% by mass or more and 10% by mass or less, based on the total mass of the liquid crystalline polyester film precursor. When the content of the medium in the liquid crystalline polyester film precursor is equal to or greater than the above lower limit value, the possibility that the thermal conductivity of the liquid crystalline polyester film decreases is reduced. In addition, when the content of the medium in the liquid crystalline polyester film precursor is equal to or less than the above upper limit value, the possibility that the appearance of the liquid crystalline polyester film is degraded by foaming or the like during the heat-treatment is reduced.

The medium is preferably removed by evaporating the medium, and examples of a method therefor include heating, depressurization, and ventilation, and these may be combined. In addition, the medium may be removed in a continuous manner or in a one-by-one manner. From the viewpoint of productivity and operability, the medium is preferably removed by heating in a continuous manner, and more preferably by heating while ventilating in a continuous manner. The temperature for medium removal is preferably a temperature lower than the temperature of the endothermic peak detected by differential scanning calorimetry of the liquid crystalline polyester powder, and is, for example, 40° C. or higher and 200° C. or lower, and preferably 40° C. or higher and 100° C. or lower. The time for medium removal is, for example, 0.2 hours or more and 12 hours or less, and preferably 0.5 hours or more and 8 hours or less.

A laminate precursor 22 having the first support 12 and the liquid crystalline polyester film precursor 40 thus obtained is heat-treated to obtain a first laminate 20 having the first support 12 and a liquid crystalline polyester film 10 (a film obtained by heat-treating the liquid crystalline polyester film precursor 40) (FIG. 1C heat-treatment step). At this time, the liquid crystalline polyester film 10 formed on the first support is obtained.

Through the heat-treatment, the polymerization reaction (solid phase polymerization) of the liquid crystalline polyester included in the liquid crystalline polyester film precursor can be carried out.

Examples of the heat-treatment condition include increasing the temperature from the temperature of 50° C. lower than the boiling point of the medium up to the heat-treatment temperature to be reached and then carrying out a heat-treatment at a temperature equal to or higher than the temperature of the endothermic peak detected by differential scanning calorimetry of the liquid crystalline polyester.

During raising the temperature, the polymerization reaction of the liquid crystalline polyester may proceed due to heating, but by increasing the temperature increase rate until the heat-treatment temperature is reached, the increase in the molecular weight of the liquid crystalline polyester in the liquid crystalline polyester powder can be suppressed to some extent, the liquid crystalline polyester powder melts well, and a high-quality film can be easily obtained. The temperature increase rate from the temperature of 50° C. lower than the boiling point of the medium to the heat-treatment temperature is preferably 3° C./min or more, and more preferably 5° C./min or more.

The heat-treatment temperature is preferably equal to or higher than the temperature of the endothermic peak detected by differential scanning calorimetry of the liquid crystalline polyester, more preferably a temperature higher than the temperature of the endothermic peak detected by differential scanning calorimetry of the liquid crystalline polyester, and even more preferably a temperature of +5° C. or higher than the temperature of the endothermic peak detected by differential scanning calorimetry of the liquid crystalline polyester. The heat-treatment temperature may be appropriately determined depending on the type of the liquid crystalline polyester, and as an example, the heat-treatment temperature is preferably 230° C. or more and 400° C. or less, more preferably 250° C. or more and 380° C. or less, and even more preferably 290° C. or more and 330° C. or less. By carrying out heat-treatment at a temperature higher than the temperature of the endothermic peak detected by differential scanning calorimetry of the liquid crystalline polyester, the liquid crystalline polyester powder melts well, and a high-quality liquid crystalline polyester film can be formed. It can be confirmed by the liquid crystalline polyester film precursor 40 having become transparent that the liquid crystalline polyester powder was able to be melted.

The boiling point of the medium here refers to the boiling point at the pressure during raising the temperature. In addition, when the heating of the laminate precursor 22 is started from lower than the temperature of 50° C. lower than the boiling point of the medium, the temperature increase rate may be set in the range from the time of reaching the temperature of 50° C. lower than the boiling point of the medium to the time of reaching the heat-treatment temperature. The time taken to reach the temperature of 50° C. lower than the boiling point of the medium is arbitrary. In addition, the time after reaching the heat-treatment temperature may be regarded as the heat-treatment time. The heat-treatment time may be, for example, 0.5 hours or more, 1 hour or more and 24 hours or less, or 2 hours or more and 12 hours or less.

As the removal of the medium, the heat-treatment may be carried out in a continuous manner or in a one-by-one manner, and from the viewpoint of productivity and operability, the heat-treatment is preferably carried out in a continuous manner, and more preferably carried out in a continuous manner following the removal of the medium.

According to the method for producing a liquid crystalline polyester film of the embodiment, since the molar ratio of the structural unit derived from an aromatic diol/the structural unit derived from an aromatic dicarboxylic acid in the liquid crystalline polyester powder contained in the liquid crystalline polyester composition used is less than 1, it is possible to provide a liquid crystalline polyester film in which the reaction of solid phase polymerization of the liquid crystalline polyester in the above heat-treatment step is difficult to proceed and the temperature increase in the endothermic peak detected by differential scanning calorimetry of the liquid crystalline polyester is suppressed. Therefore, in the case of producing a second laminate through a lamination step later, the liquid crystalline polyester is easily melted by heating, and the laminated liquid crystalline polyester film adheres well to a second support.

In addition, according to the method for producing a liquid crystalline polyester film of the embodiment, it is possible to produce a liquid crystalline polyester film having excellent isotropy.

In the conventional melt molding method, a thin film of liquid crystalline polyester is produced by forming melted liquid crystalline polyester into a film, whereas in the above production method of the embodiment, the liquid crystalline polyester powder is placed thinly on the support in advance and then melted, which is significantly different from the conventional method for producing a film.

In the method for producing a liquid crystalline polyester film of the embodiment, the liquid crystalline polyester powder is placed thinly on the support in advance and then formed into a film, and thus no physical force is applied that could cause bias in the molecular orientation, such as extrusion molding, and it is possible to produce a liquid crystalline polyester film having excellent isotropy.

Moreover, in the liquid crystalline polyester composition, there is no restriction that the liquid crystalline polyester powder should be soluble in a medium, and thus a liquid crystalline polyester having excellent dielectric properties can be adopted, and it is possible to easily obtain a liquid crystalline polyester film having excellent dielectric properties and isotropy.

### <<Method for Producing First Laminate>>

The method for producing a first laminate of the embodiment comprises applying the liquid crystalline polyester composition according to the embodiment onto a first support and performing a heat-treatment to form a liquid crystalline polyester film comprising the liquid crystalline polyester, thereby obtaining a first laminate comprising the first support and the liquid crystalline polyester film.

The production method may comprise the following steps.

A step of applying the liquid crystalline polyester composition according to the embodiment onto a first support to form a liquid crystalline polyester film precursor on the first support (application step).

A step of heat-treating the liquid crystalline polyester film precursor to obtain a first laminate comprising the first support and the liquid crystalline polyester film (heat-treatment step).

In the same way as the above method for producing a liquid crystalline polyester film, the application step in the method for producing a first laminate may comprise, after applying the liquid crystalline polyester composition according to the embodiment onto a first support, a step of removing the medium from the applied liquid crystalline polyester composition (drying step).

That is, the method for producing a first laminate of the embodiment may comprise applying the liquid crystalline polyester composition according to the embodiment onto a first support, removing the medium from the applied liquid crystalline polyester composition, and performing a heat-treatment to form a liquid crystalline polyester film comprising the liquid crystalline polyester, thereby obtaining a first laminate comprising the first support and the liquid crystalline polyester film.

FIGS. 1A to 1C are schematic diagrams showing an example of a production process of the first laminate of the embodiment. The method for producing a first laminate given as an example in FIGS. 1A to 1C is as described in the above <<Method for producing liquid crystalline polyester film>>, and thus the description thereof will be omitted.

According to the method for producing a first laminate of the embodiment, it is possible to produce a first laminate having the liquid crystalline polyester film of the embodiment.

According to the method for producing a first laminate of the embodiment, it is possible to provide a first laminate comprising a liquid crystalline polyester film in which the reaction of solid phase polymerization of the liquid crystalline polyester in the above heat-treatment step is difficult to proceed and the temperature increase in the endothermic peak detected by differential scanning calorimetry of the liquid crystalline polyester is suppressed. Thereby, the liquid crystalline polyester film and a second support bonded together through a subsequent lamination step can adhere well to each other.

### <<Method for Producing Second Laminate>>

The method for producing a second laminate of the embodiment comprises, after obtaining a first laminate by the method for producing a first laminate, laminating a second support on the surface of the liquid crystalline polyester film of the first laminate opposite to the surface on which the first support is laminated to obtain a second laminate.

The production method may comprise the following steps.

A step of applying the liquid crystalline polyester composition according to the embodiment onto a first support to form a liquid crystalline polyester film precursor on the first support (application step).

A step of heat-treating the liquid crystalline polyester film precursor to obtain a first laminate comprising the first support and the liquid crystalline polyester film (heat-treatment step).

A step of laminating a second support on the surface of the liquid crystalline polyester film opposite to the surface on which the first support is laminated to obtain a second laminate (lamination step).

In the lamination step, it is preferable to laminate a second support on the surface of the liquid crystalline polyester film opposite to the surface on which the first support is laminated, to heat the liquid crystalline polyester film to melt the liquid crystalline polyester, and to bond the liquid crystalline polyester film and the second support together to obtain a second laminate. Examples of the method for heating the liquid crystalline polyester film to melt the liquid crystalline polyester and laminating the second support include the lamination method. Examples of the lamination method include methods such as a method in which a roller is used for heating and pressure bonding, a method in which a pressing apparatus is used for heating and pressure bonding, and a vacuum lamination method in which a vacuum heat pressing apparatus is used for heating and pressure bonding.

The heating temperature for the liquid crystalline polyester film in the lamination step (set temperature of the heating apparatus) may be 300 to 350° C., may be 310 to 340° C., or may be 320 to 330° C., for example.

The method for producing a second laminate of the embodiment may comprise: applying the liquid crystalline polyester composition according to claim 11 onto a first support and performing a heat-treatment to form a liquid crystalline polyester film comprising the liquid crystalline polyester, thereby obtaining a first laminate comprising the first support and the liquid crystalline polyester film; and
laminating a second support on the surface of the liquid crystalline polyester film of the first laminate opposite to the surface on which the first support is laminated, heating the liquid crystalline polyester film, and bonding the liquid crystalline polyester film and the second support together to obtain a second laminate.

FIGS. 1A to 1D are schematic diagrams showing an example of a production process of the second laminate of the embodiment. The description up to the heat-treatment step in FIG. 1C is the same as described in the above <<Method for producing liquid crystalline polyester film>>, and thus the description thereof will be omitted.

Next, after the heat treatment step (FIG. 1C), for the first laminate 20 having the first support 12 and the liquid crystalline polyester film 10, a second support 13 can be laminated on the surface of the liquid crystalline polyester film 10 opposite to the surface on which the first support 12 is laminated (FIG. 1D lamination step). Preferably, the second support 13 is laminated on the surface of the liquid crystalline polyester film 10 opposite to the surface on which the first support 12 is laminated, the liquid crystalline polyester film 10 is heated to melt the liquid crystalline polyester, and the liquid crystalline polyester film 10 and the second support 13 are bonded together. Thereby, a second laminate 21 is obtained, in which the first support 12, the liquid crystalline polyester film 10, and the second support 13 are laminated in this order.

As the second support 13, those exemplified above as the first support can be adopted, and examples thereof include a glass plate, a resin film, or a metal foil, with a copper foil being preferable.

The second laminate is preferably one in which the copper foil, the liquid crystalline polyester film, and the copper foil are laminated in this order.

According to the method for producing a second laminate of the embodiment, it is possible to produce a second laminate having the liquid crystalline polyester film of the embodiment.

According to the method for producing a second laminate of the embodiment, the reaction of solid phase polymerization of the liquid crystalline polyester in the above heat-treatment step is difficult to proceed and the temperature increase in the endothermic peak of the liquid crystalline polyester is unlikely to occur.

Thereby, it is possible to provide a second laminate in which the liquid crystalline polyester film and the second support adhere well to each other after the lamination step.

### <<Liquid Crystalline Polyester Film>>

FIG. 2 is a schematic diagram showing a configuration of the liquid crystalline polyester film 10 of the embodiment.

The liquid crystalline polyester film of the embodiment (hereinafter, sometimes simply referred to as the “film”) comprises a liquid crystalline polyester having a structural unit derived from an aromatic diol and a structural unit derived from an aromatic dicarboxylic acid, and the molar ratio of the structural unit derived from an aromatic diol/the structural unit derived from an aromatic dicarboxylic acid in the liquid crystalline polyester is less than 1. Examples of the liquid crystalline polyester include those given above as examples in the above <<Liquid crystalline polyester powder>>, and a polymer obtained by condensation polymerization (polycondensation) of an aromatic hydroxycarboxylic acid, an aromatic dicarboxylic acid, and an aromatic diol is preferable.

The liquid crystalline polyester preferably comprises a structural unit comprising a naphthalene structure.

The content of the structural unit comprising a naphthalene structure may be 40 mol % or more, may be 40 mol % or more and 90 mol % or less, may be 50 mol % or more and 85 mol % or less, may be 55 mol % or more and 85 mol % or less, or may be 60 mol % or more and 80 mol % or less, based on 100 mol % of the total amount of all structural units in the liquid crystalline polyester.

The liquid crystalline polyester preferably has a structural unit represented by the following formula (1), a structural unit represented by the following formula (2), and a structural unit represented by the following formula (3):

—O—Ar1-CO— (1)

—CO—Ar2-CO— (2)

—O—Ar3-O— (3)
wherein Ar represents a 2,6-naphthylene group, a 1,4-phenylene group, or a 4,4′-biphenylylene group;
Ar2 and Ar3 each independently represent a 2,6-naphthylene group, a 2,7-naphthylene group, a 1,4-phenylene group, a 1,3-phenylene group, or a 4,4′-biphenylylene group; and
hydrogen atoms in the group represented by Ar1, Ar2, or Ar3 are each independently optionally replaced with a halogen atom, an alkyl group having 1 to 10 carbon atoms, or an aryl group having 6 to 20 carbon atoms.

For the liquid crystalline polyester, Ar1 preferably represents a 2,6-naphthylene group or a 1,4-phenylene group, and Ar2 and Ar3 preferably each independently represent a 2,6-naphthylene group, a 2,7-naphthylene group, a 1,4-phenylene group, or a 1,3-phenylene group. (Hydrogen atoms in the group represented by Ar1, Ar2, or Ar3 are each independently optionally replaced with a halogen atom, an alkyl group having 1 to 10 carbon atoms, or an aryl group having 6 to 20 carbon atoms.)

For the liquid crystalline polyester, Ar1 preferably represents a 2,6-naphthylene group, and Ar2 and Ar3 preferably each independently represent a 2,6-naphthylene group or a 1,4-phenylene group. (Hydrogen atoms in the group represented by Ar1, Ar2, or Ar3 are each independently optionally replaced with a halogen atom, an alkyl group having 1 to 10 carbon atoms, or an aryl group having 6 to 20 carbon atoms.)

The molar ratio of the structural unit represented by the formula (3)/the structural unit represented by the formula (2) in the liquid crystalline polyester may be less than 1, may be 0.70 or more and less than 1, may be 0.75 or more and 0.95 or less, may be 0.8 or more and 0.93 or less, may be 0.81 or more and 0.90 or less, or may be 0.82 or more and 0.88 or less.

The liquid crystalline polyester in the liquid crystalline polyester film of the embodiment preferably has a relative permittivity at a frequency of 1 GHz of 3 or less, preferably has a dielectric loss tangent at a frequency of 1 GHz of 0.005 or less, and preferably has a value of the molecular orientation ratio (MOR) measured using a microwave orientation meter in the range of 1 to 1.3.

A film satisfying the above requirements has suitable quality as a film for electronic components. Examples of the standards of the quality include the above relative permittivity, dielectric loss tangent, and molecular orientation ratio (isotropy of the film), and other factors such as thickness and appearance (presence or absence of the occurrence of a hole or a through hole) are taken into consideration.

As an example, the values of the relative permittivity and the dielectric loss tangent of the film can be controlled by the type of the liquid crystalline polyester. In addition, as an example, the degree of isotropy of the film can be controlled by the method for producing the film.

The film of the embodiment has a relative permittivity at a frequency of 1 GHz of, preferably 3 or less, preferably 2.9 or less, more preferably 2.8 or less, even more preferably 2.7 or less, and particularly preferably 2.6 or less. In addition, the relative permittivity of the film may be 2.3 or more, 2.4 or more, or 2.5 or more.

An example of the numerical range of a value of the relative permittivity of the film may be 2.3 or more and 3 or less, 2.4 or more and 2.9 or less, 2.5 or more and 2.8 or less, 2.5 or more and 2.7 or less, and 2.5 or more and 2.6 or less.

The film of the embodiment has a dielectric loss tangent at a frequency of 1 GHz of, preferably, 0.005 or less, preferably 0.004 or less, more preferably 0.003 or less, even more preferably 0.002 or less, and particularly preferably 0.001 or less. In addition, the dielectric loss tangent of the liquid crystalline polyester film may be 0.0003 or more, 0.0005 or more, or 0.0007 or more.

An example of the numerical range of a value of the dielectric loss tangent of the film may be 0.0003 or more and 0.005 or less, 0.0005 or more and 0.004 or less, 0.0007 or more and 0.003 or less, 0.0007 or more and 0.002 or less, or 0.0007 or more and 0.001 or less.

The relative permittivity and the dielectric loss tangent at a frequency of 1 GHz of the film can be measured under the following conditions by a capacitance method using an impedance analyzer.

The film is melted at 350° C. using a flow tester and then cooled and solidified to manufacture a tablet having a diameter of 1 cm and a thickness of 0.5 cm. The relative permittivity and the dielectric loss tangent at 1 GHz of the obtained tablet are measured under the following conditions.
Measurement method: Capacitance method
Electrode model: 16453A
Measurement environment: 23° C., 50% RH
Applied voltage: 1 V

The film of the embodiment has a value of the molecular orientation ratio (MOR) measured using a microwave orientation meter preferably in the range of 1 to 1.3, preferably in the range of 1 to 1.1, preferably in the range of 1 to 1.08, more preferably in the range of 1 to 1.06, and even more preferably in the range of 1 to 1.04.

The molecular orientation ratio (MOR) is measured using a microwave molecular orientation meter (for example, MOA-5012A manufactured by Oji Scientific Instruments Co., Ltd.). The microwave molecular orientation meter is an apparatus that utilizes the fact that the transmission intensity of a microwave differs between the orientation direction and a perpendicular direction depending on the orientation of molecules.

Specifically, a sample is irradiated with a microwave having a constant frequency (12 GHz is used) while rotating the sample, the intensity of the transmitted microwave that changes depending on the orientation of the molecules is measured, and the ratio of maximum value/minimum value thereof is defined as MOR. The interaction between a microwave electric field having a constant frequency and the dipoles that constitute the molecules relates to the inner product of the vectors of the both. Because of the anisotropy of the permittivity of the sample, the intensity of the microwave changes depending on the angle at which the sample is disposed, and this is why the orientation ratio is measured.

The film of the embodiment preferably has a linear expansion coefficient determined in the temperature range between 50° C. and 100° C. under a condition of a temperature increase rate of 5° C./min of 85 ppm/° C. or less, more preferably 50 ppm/° C. or less, even more preferably 40 ppm/° C. or less, and particularly preferably 30 ppm/° C. or less. The lower limit value of the linear expansion coefficient is not particularly limited, and is, for example, 0 ppm/° C. or more. In addition, the linear expansion coefficient of a copper foil is 18 ppm/° C., and thus for example, when the copper foil and the film are laminated, the linear expansion coefficient of the film of the embodiment is preferably a value close to that value. That is, the linear expansion coefficient of the film of the embodiment is preferably 0 ppm/° C. or more and 50 ppm/° C. or less, more preferably 10 ppm/° C. or more and 40 ppm/° C. or less, and even more preferably 20 ppm/° C. or more and 30 ppm/° C. or less. When the linear expansion coefficient differs depending on the direction or part of the film, the higher value is adopted as the linear expansion coefficient of the film. The linear expansion coefficient of the film can be measured using a thermomechanical analyzer (for example, model: TMA8310, manufactured by Rigaku Corporation). The film of the embodiment satisfying the above numerical range has a low linear expansion coefficient and high dimensional stability.

A film having excellent isotropy has a small difference in linear expansion coefficient depending on the measurement direction.

For the film of the embodiment, in the above linear expansion coefficient, the difference between the linear expansion coefficient in MD and the linear expansion coefficient in TD (MD−TD when MD> TD, and TD−MD when TD>MD) is preferably 2 ppm/° C. or less, and more preferably 1 ppm/° C. or less. In the film formed by the casting method, MD is the applying direction of the dispersion. As in the calculation of the above difference in the linear expansion coefficient, in reality, it is necessary to know the linear expansion coefficients in different directions, and thus, if MD and TD of the film are unknown, when any direction of the film is taken as MD and the direction that intersects at 90° therewith is taken as TD, the directions may be set so that the difference between the linear expansion coefficients in those directions may be the largest.

The film of the embodiment satisfying the above numerical range has excellent isotropy in linear expansion and high dimensional stability in the longitudinal direction and transverse direction.

The film of the embodiment preferably has no hole or through hole as an appearance suitable for a film for an electronic part. When the film has a hole or a through hole, a plating liquid may seep into the hole or the through hole during plating. The liquid crystalline polyester film produced from the liquid crystalline polyester powder according to the embodiment as a raw material is of high quality, having a thickness suitable for a film for an electronic part and having the generation of a hole or a through hole suppressed.

The thickness of the film of the embodiment is not particularly limited, and the thickness suitable for a film for an electronic part is preferably 5 to 50 μm, more preferably 7 to 40 μm, even more preferably 10 to 33 μm, and particularly preferably 15 to 20 μm.

In the present description, the “thickness” is the average value of values obtained by measuring the thickness at 10 randomly selected places in accordance with a JIS standard (K7130-1992).

A film having excellent dielectric properties can be obtained by selecting a raw material having excellent dielectric properties from any liquid crystalline polyester.

The proportion of the content of the liquid crystalline polyester based on a total mass of the film of the embodiment of 100% by mass may be 50 to 100% by mass or 80 to 95% by mass.

Based on 100% by mass of the sum of liquid crystalline polyesters contained in the film of the embodiment, the above liquid crystalline polyester of the embodiment may be contained in an amount of more than 70% by mass and 100% by mass or less, or 80 to 100% by mass. Examples of the liquid crystalline polyester include those given above as examples in the liquid crystalline polyester powder according to the embodiment, and for example, it is one having the structural unit represented by the above formula (1), a liquid crystalline polyester having the structural unit represented by the above formula (1), the structural unit represented by the above formula (2), and the structural unit represented by the above formula (3). At least one copolymer selected from the group consisting of 1) to 34) listed above as specific examples of the preferable liquid crystalline polyester described above can also be given as an example.

The film of the embodiment may be a film that comprises the liquid crystalline polyester, has a relative permittivity at a frequency of 1 GHz of 3 or less, has a dielectric loss tangent at a frequency of 1 GHz of 0.005 or less, and has a value of the molecular orientation ratio (MOR) measured using a microwave orientation meter in the range of 1 to 1.3 (however, the content of a liquid crystalline polyester soluble in an aprotic solvent is less than 5% by mass based on 100% by mass of the sum of liquid crystalline polyesters).

The film of the embodiment may be a film that comprises the liquid crystalline polyester, has a relative permittivity at a frequency of 1 GHz of 3 or less, has a dielectric loss tangent at a frequency of 1 GHz of 0.005 or less, and has a value of the molecular orientation ratio (MOR) measured using a microwave orientation meter in the range of 1 to 1.3 (however, the content of a liquid crystalline polyester soluble in a medium according to the liquid crystalline polyester composition of the embodiment is less than 5% by mass based on 100% by mass of the sum of liquid crystalline polyesters).

The film of the embodiment may be a film that comprises the liquid crystalline polyester, has a relative permittivity at a frequency of 1 GHz of 3 or less, has a dielectric loss tangent at a frequency of 1 GHz of 0.005 or less, and has a value of the molecular orientation ratio (MOR) measured using a microwave orientation meter in the range of 1 to 1.3 (however, those comprising a liquid crystalline polyester soluble in an aprotic solvent are excluded).

The film of the embodiment may be a film that comprises the liquid crystalline polyester, has a relative permittivity at a frequency of 1 GHz of 3 or less, has a dielectric loss tangent at a frequency of 1 GHz of 0.005 or less, and has a value of the molecular orientation ratio (MOR) measured using a microwave orientation meter in the range of 1 to 1.3 (however, those comprising a liquid crystalline polyester soluble in a medium according to the liquid crystalline polyester composition of the embodiment are excluded).

Here, examples of the liquid crystalline polyester soluble in an aprotic solvent or media include those give above as examples in the liquid crystalline polyester powder according to the embodiment.

The method for producing the film of the embodiment is not particularly limited, and the film of the embodiment can be produced by the above <<Method for producing liquid crystalline polyester film>>.

The film of the embodiment can be suitably used for a use of a film for an electronic part such as a printed wiring board. The film of the embodiment can be provided as a substrate (for example, a flexible substrate), a laminated plate (for example, a flexible copper-clad laminated plate), a printed board, a printed wiring board, a printed circuit board, or the like, which comprise the film as an insulating material.

### <<First Laminate>>

The first laminate of the embodiment comprises a first metal layer and the film according to the embodiment laminated on the first metal layer.

FIG. 3 is a schematic diagram showing a configuration of a first laminate 23 according to one embodiment of the present invention. The first laminate 23 comprises a first metal layer 14 and a liquid crystalline polyester film 10 laminated on the first metal layer 14.

Examples of the liquid crystalline polyester film included in the laminate include those given above as examples, and the description thereof will be omitted.

Examples of the first metal layer included in the laminate include those given as examples of the first support in the above <<Method for producing liquid crystalline polyester film>> and <<Method for producing first laminate>>, and a metal foil is preferable. Copper is preferable as a metal constituting the first metal layer from the viewpoint of electric conductivity and cost, and a copper foil is preferable as the metal foil.

The thickness of the first laminate of the embodiment is not particularly limited, and is preferably 5 to 130 μm, more preferably 10 to 70 μm, and even more preferably 15 to 60 μm.

The method for producing the first laminate of the embodiment is not particularly limited, and the first laminate of the embodiment can be produced by the above <<Method for producing first laminate>>.

The first laminate of the embodiment can be suitably used for a use of a laminated plate for electronic components, such as a laminated plate (for example, a flexible copper-clad laminated plate).

### <<Second Laminate>>

The second laminate of the embodiment comprises a first metal layer, a liquid crystalline polyester film laminated on the first metal layer, and a second metal layer laminated on the surface of the liquid crystalline polyester film opposite to the surface on which the first metal layer is laminated.

FIG. 4 is a schematic diagram showing a configuration of a second laminate 24 of one embodiment of the present invention. The second laminate 24 comprises a first metal layer 14, a liquid crystalline polyester film 10 laminated on the first metal layer 14, and a second metal layer 15 laminated on the surface of the liquid crystalline polyester film 10 opposite to the surface on which the first metal layer 14 is laminated.

Examples of the liquid crystalline polyester film included in the second laminate include those given above as examples in the above <<Method for producing liquid crystalline polyester film>>, and the description thereof will be omitted.

Examples of the first metal layer and the second metal layer included in the second laminate include those given as examples of the first support in the above <<Method for producing liquid crystalline polyester film>>, and a metal foil is preferable. Copper is preferable as a metal constituting the first metal layer and the second metal layer from the viewpoint of electric conductivity and cost, and a copper foil is preferable as the metal foil of the first metal layer and the second metal layer.

The thickness of the second laminate of the embodiment is not particularly limited, and is preferably 5 to 130 m, more preferably 10 to 70 m, and even more preferably 15 to 60 μm.

The method for producing the second laminate of the embodiment is not particularly limited, and the second laminate of the embodiment can be produced by the above <<Method for producing second laminate>>.

The second laminate of the embodiment can be suitably used for a use of a laminated plate for electronic components, such as a laminated plate (for example, a double-sided flexible copper-clad laminated plate).

### EXAMPLES

Next, the present invention will be described in more detail with reference to Examples, but the present invention is not limited to the following Examples.

### <<Measurement Methods>>

### [Measurement of Endothermic Peak of Liquid Crystalline Polyester]

Using a liquid crystalline polyester as the sample, the temperature (° C.) at the apex position of the endothermic peak of the liquid crystalline polyester was measured by increasing the temperature from room temperature (23° C.) at a rate of 10° C./min using a differential scanning calorimeter (“DSC-60A Plus” from Shimadzu Corporation).

### [Measurement of Flow Starting Temperature of Liquid Crystalline Polyester]

Using a flow tester (“model CFT-500” from Shimadzu Corporation), a cylinder equipped with a die having a nozzle having an inner diameter of 1 mm and a length of 10 mm was filled with about 2 g of a liquid crystalline polyester, the liquid crystalline polyester was melted and extruded through the nozzle while increasing the temperature at a rate of 4° C./min under a load of 9.8 MPa (100 kg/cm²), and the temperature (° C.) exhibiting a viscosity of 4800 Pa-s (48000 P) was measured as the flow starting temperature of the liquid crystalline polyester.

### Production of Liquid Crystalline Polyester Powder

### Example 1

Into a reactor equipped with a stirrer, a torque meter, a nitrogen gas introduction tube, a thermometer, and a reflux cooler were added 1034.99 g (5.5 mol) of 2-hydroxy-6-naphthoic acid, 378.33 g (1.75 mol) of 2,6-naphthalenedicarboxylic acid, 174.4 g (1.05 mol) of terephthalic acid, 255.2 g (2.318 mol) of hydroquinone, 1189.90 g (11.66 mol) of acetic anhydride, and 0.17 g of 1-methylimidazole as a catalyst. The gas in the reactor was replaced with nitrogen gas, then the temperature was increased from room temperature to 145° C. over 15 minutes while stirring in a nitrogen gas stream, and the resulting mixture was refluxed at 145° C. for 1 hour.

In the above monomers, the molar ratio of hydroquinone (aromatic diol)/2,6-naphthalenedicarboxylic acid and terephthalic acid (aromatic dicarboxylic acids) is 0.828.

Next, while distilling off by-produced acetic acid and unreacted acetic anhydride, the temperature was increased from 145° C. to 310° C. over 3 hours and 30 minutes, held at 310° C. for 120 minutes, and then the contents were drained into a SUS tray, and cooled to room temperature and solidified to obtain a liquid crystalline polyester (A1) in the form of a solid. The flow starting temperature of this liquid crystalline polyester (A1) was 249.9° C.

The liquid crystalline polyester (A1) has, based on the total amount (100 mol %) of all repeating structural units,
52 mol % of a structural unit (1) in which Ar1 is a 2,6-naphthylene group,
16 mol % of a structural unit (2) in which Ar2 is a 2,6-naphthylene group,
10 mol % of a structural unit (2) in which Ar2 is a 1,4-phenylene group, and
22 mol % of a structural unit (3) in which Ar3 is a 1,4-phenylene group.

In the above liquid crystalline polyester (A1), the molar ratio of the structural unit derived from hydroquinone (aromatic diol)/the structural units derived from 2,6-naphthalenedicarboxylic acid and terephthalic acid (aromatic dicarboxylic acids) is 0.828.

The obtained liquid crystalline polyester was pulverized using a 2 mm perforated metal screen (pulverizing screen) and a pulverizer (model: VM-16, rotation speed: 1500 rpm) manufactured by Orient Pulverizer K.K. to obtain a liquid crystalline polyester powder of Example 1.

### Example 2

Into a reactor equipped with a stirrer, a torque meter, a nitrogen gas introduction tube, a thermometer, and a reflux cooler were added 1034.99 g (5.5 mol) of 2-hydroxy-6-naphthoic acid, 378.33 g (1.75 mol) of 2,6-naphthalenedicarboxylic acid, 149.50 g (0.9 mol) of terephthalic acid, 255.2 g (2.318 mol) of hydroquinone, and 0.17 g of 1-methylimidazole as a catalyst. The gas in the reactor was replaced with nitrogen gas, then the temperature was increased from room temperature to 145° C. over 15 minutes while stirring in a nitrogen gas stream, and the resulting mixture was refluxed at 145° C. for 1 hour.

In the above monomers, the molar ratio of hydroquinone (aromatic diol)/2,6-naphthalenedicarboxylic acid and terephthalic acid (aromatic dicarboxylic acids) is 0.875.

Next, while distilling off by-produced acetic acid and unreacted acetic anhydride, the temperature was increased from 145° C. to 310° C. over 3 hours and 30 minutes, held at 310° C. for 120 minutes, and then the contents were drained into a SUS tray, and cooled to room temperature and solidified to obtain a liquid crystalline polyester (A2) in the form of a solid. The flow starting temperature of this liquid crystalline polyester (A2) was 254.4° C.

The liquid crystalline polyester (A2) has, based on the total amount (100 mol %) of all repeating structural units,
53 mol % of a structural unit (1) in which Ar1 is a 2,6-naphthylene group,
17 mol % of a structural unit (2) in which Ar2 is a 2,6-naphthylene group,
9 mol % of a structural unit (2) in which Ar2 is a 1,4-phenylene group, and
22 mol % of a structural unit (3) in which Ar3 is a 1,4-phenylene group.

In the above liquid crystalline polyester (A2), the molar ratio of the structural unit derived from hydroquinone (aromatic diol)/the structural units derived from 2,6-naphthalenedicarboxylic acid and terephthalic acid (aromatic dicarboxylic acids) is 0.875.

The obtained liquid crystalline polyester was pulverized using a 2 mm perforated metal screen (pulverizing screen) and a pulverizer (model: VM-16, rotation speed: 1500 rpm) manufactured by Orient Pulverizer K.K. to obtain a liquid crystalline polyester powder of Example 2.

### Example 3

Into a reactor equipped with a stirrer, a torque meter, a nitrogen gas introduction tube, a thermometer, and a reflux cooler were added 1034.99 g (5.5 mol) of 2-hydroxy-6-naphthoic acid, 378.33 g (1.75 mol) of 2,6-naphthalenedicarboxylic acid, 132.90 g (0.8 mol) of terephthalic acid, 255.2 g (2.318 mol) of hydroquinone, 1189.90 g (11.66 mol) of acetic anhydride, and 0.17 g of 1-methylimidazole as a catalyst. The gas in the reactor was replaced with nitrogen gas, then the temperature was increased from room temperature to 145° C. over 15 minutes while stirring in a nitrogen gas stream, and the resulting mixture was refluxed at 145° C. for 1 hour.

In the above monomers, the molar ratio of hydroquinone (aromatic diol)/2,6-naphthalenedicarboxylic acid and terephthalic acid (aromatic dicarboxylic acids) is 0.909.

Next, while distilling off by-produced acetic acid and unreacted acetic anhydride, the temperature was increased from 145° C. to 310° C. over 3 hours and 30 minutes, held at 310° C. for 120 minutes, and then the contents were drained into a SUS tray, and cooled to room temperature and solidified to obtain a liquid crystalline polyester (A3) in the form of a solid. The flow starting temperature of this liquid crystalline polyester (A3) was 254.7° C.

The liquid crystalline polyester (A3) has, based on the total amount (100 mol %) of all repeating structural units,
53 mol % of a structural unit (1) in which Ar1 is a 2,6-naphthylene group,
17 mol % of a structural unit (2) in which Ar2 is a 2,6-naphthylene group,
8 mol % of a structural unit (2) in which Ar2 is a 1,4-phenylene group, and
22 mol % of a structural unit (3) in which Ar3 is a 1,4-phenylene group.

In the above liquid crystalline polyester (A3), the molar ratio of the structural unit derived from hydroquinone (aromatic diol)/the structural units derived from 2,6-naphthalenedicarboxylic acid and terephthalic acid (aromatic dicarboxylic acids) is 0.909.

The obtained liquid crystalline polyester was pulverized using a 2 mm perforated metal screen (pulverizing screen) and a pulverizer (model: VM-16, rotation speed: 1500 rpm) manufactured by Orient Pulverizer K.K. to obtain a liquid crystalline polyester powder of Example 3.

### Example 4

Into a reactor equipped with a stirrer, a torque meter, a nitrogen gas introduction tube, a thermometer, and a reflux cooler were added 1034.99 g (5.5 mol) of 2-hydroxy-6-naphthoic acid, 378.33 g (1.75 mol) of 2,6-naphthalenedicarboxylic acid, 116.30 g (0.7 mol) of terephthalic acid, 255.2 g (2.318 mol) of hydroquinone, 1189.90 g (11.66 mol) of acetic anhydride, and 0.17 g of 1-methylimidazole as a catalyst. The gas in the reactor was replaced with nitrogen gas, then the temperature was increased from room temperature to 145° C. over 15 minutes while stirring in a nitrogen gas stream, and the resulting mixture was refluxed at 145° C. for 1 hour.

In the above monomers, the molar ratio of hydroquinone (aromatic diol)/2,6-naphthalenedicarboxylic acid and terephthalic acid (aromatic dicarboxylic acids) is 0.946.

Next, while distilling off by-produced acetic acid and unreacted acetic anhydride, the temperature was increased from 145° C. to 310° C. over 3 hours and 30 minutes, held at 310° C. for 120 minutes, and then the contents were drained into a SUS tray, and cooled to room temperature and solidified to obtain a liquid crystalline polyester (A4) in the form of a solid. The flow starting temperature of this liquid crystalline polyester (A4) was 260.7° C.

The liquid crystalline polyester (A4) has, based on the total amount (100 mol %) of all repeating structural units,
54 mol % of a structural unit (1) in which Ar1 is a 2,6-naphthylene group,
17 mol % of a structural unit (2) in which Ar2 is a 2,6-naphthylene group,
7 mol % of a structural unit (2) in which Ar2 is a 1,4-phenylene group, and
23 mol % of a repeating unit (3) in which Ar3 is a 1,4-phenylene group.

In the above liquid crystalline polyester (A4), the molar ratio of the structural unit derived from hydroquinone (aromatic diol)/the structural units derived from 2,6-naphthalenedicarboxylic acid and terephthalic acid (aromatic dicarboxylic acids) is 0.946.

The obtained liquid crystalline polyester was pulverized using a 2 mm perforated metal screen (pulverizing screen) and a pulverizer (model: VM-16, rotation speed: 1500 rpm) manufactured by Orient Pulverizer K.K. to obtain a liquid crystalline polyester powder of Example 4.

### Comparative Example 1

Into a reactor equipped with a stirrer, a torque meter, a nitrogen gas introduction tube, a thermometer, and a reflux cooler were added 1034.99 g (5.5 mol) of 2-hydroxy-6-naphthoic acid, 378.33 g (1.75 mol) of 2,6-naphthalenedicarboxylic acid, 83.07 g (0.5 mol) of terephthalic acid, 255.2 g (2.318 mol) of hydroquinone, 1189.90 g (11.66 mol) of acetic anhydride, and 0.17 g of 1-methylimidazole as a catalyst. The gas in the reactor was replaced with nitrogen gas, then the temperature was increased from room temperature to 145° C. over 15 minutes while stirring in a nitrogen gas stream, and the resulting mixture was refluxed at 145° C. for 1 hour.

In the above monomers, the molar ratio of hydroquinone (aromatic diol)/2,6-naphthalenedicarboxylic acid and terephthalic acid (aromatic dicarboxylic acids) is 1.030.

Next, while distilling off by-produced acetic acid and unreacted acetic anhydride, the temperature was increased from 145° C. to 310° C. over 3 hours and 30 minutes, held at 310° C. for 120 minutes, and then the contents were drained into a SUS tray, and cooled to room temperature and solidified to obtain a liquid crystalline polyester (A5) in the form of a solid. The flow starting temperature of this liquid crystalline polyester (A5) was 264.2° C.

The liquid crystalline polyester (A5) has, based on the total amount (100 mol %) of all repeating structural units,
55 mol % of a structural unit (1) in which Ar1 is a 2,6-naphthylene group,
17 mol % of a structural unit (2) in which Ar2 is a 2,6-naphthylene group,
5 mol % of a structural unit (2) in which Ar2 is a 1,4-phenylene group, and
23 mol % of a structural unit (3) in which Ar3 is a 1,4-phenylene group.

In the above liquid crystalline polyester (A5), the molar ratio of the structural unit derived from hydroquinone (aromatic diol)/the structural units derived from 2,6-naphthalenedicarboxylic acid and terephthalic acid (aromatic dicarboxylic acids) is 1.030.

The obtained liquid crystalline polyester was pulverized using a 2 mm perforated metal screen (pulverizing screen) and a pulverizer (model: VM-16, rotation speed: 1500 rpm) manufactured by Orient Pulverizer K.K. to obtain a liquid crystalline polyester powder of Comparative Example 1.

### Comparative Example 2

Into a reactor equipped with a stirrer, a torque meter, a nitrogen gas introduction tube, a thermometer, and a reflux cooler were added 1034.99 g (5.5 mol) of 2-hydroxy-6-naphthoic acid, 378.33 g (1.75 mol) of 2,6-naphthalenedicarboxylic acid, 83.07 g (0.5 mol) of terephthalic acid, 258.8 g (2.35 mol) of hydroquinone, 1189.90 g (11.66 mol) of acetic anhydride, and 0.17 g of 1-methylimidazole as a catalyst. The gas in the reactor was replaced with nitrogen gas, then the temperature was increased from room temperature to 145° C. over 15 minutes while stirring in a nitrogen gas stream, and the resulting mixture was refluxed at 145° C. for 1 hour.

In the above monomers, the molar ratio of hydroquinone (aromatic diol)/2,6-naphthalenedicarboxylic acid and terephthalic acid (aromatic dicarboxylic acids) is 1.044.

Next, while distilling off by-produced acetic acid and unreacted acetic anhydride, the temperature was increased from 145° C. to 310° C. over 3 hours and 30 minutes, held at 310° C. for 120 minutes, and then the contents were drained into a SUS tray, and cooled to room temperature and solidified to obtain a liquid crystalline polyester (A6) in the form of a solid. The flow starting temperature of this liquid crystalline polyester (A6) was 269.5° C.

The liquid crystalline polyester (A6) has, based on the total amount (100 mol %) of all repeating structural units,
54 mol % of a structural unit (1) in which Ar1 is a 2,6-naphthylene group,
17 mol % of a structural unit (2) in which Ar2 is a 2,6-naphthylene group,
5 mol % of a structural unit (2) in which Ar2 is a 1,4-phenylene group, and
23 mol % of a repeating unit (3) in which Ar3 is a 1,4-phenylene group.

In the above liquid crystalline polyester (A6), the molar ratio of the structural unit derived from hydroquinone (aromatic diol)/the structural units derived from 2,6-naphthalenedicarboxylic acid and terephthalic acid (aromatic dicarboxylic acids) is 1.044.

The obtained liquid crystalline polyester was pulverized using a 2 mm perforated metal screen (pulverizing screen) and a pulverizer (model: VM-16, rotation speed: 1500 rpm) manufactured by Orient Pulverizer K.K. to obtain a liquid crystalline polyester powder of Comparative Example 2.

### Comparative Example 3

Into a reactor equipped with a stirrer, a torque meter, a nitrogen gas introduction tube, a thermometer, and a reflux cooler were added 1034.99 g (5.5 mol) of 2-hydroxy-6-naphthoic acid, 378.33 g (1.75 mol) of 2,6-naphthalenedicarboxylic acid, 83.07 g (0.5 mol) of terephthalic acid, 275.3 g (2.5 mol) of hydroquinone, 1189.90 g (11.66 mol) of acetic anhydride, and 0.17 g of 1-methylimidazole as a catalyst. The gas in the reactor was replaced with nitrogen gas, then the temperature was increased from room temperature to 145° C. over 15 minutes while stirring in a nitrogen gas stream, and the resulting mixture was refluxed at 145° C. for 1 hour.

In the above monomers, the molar ratio of hydroquinone (aromatic diol)/2,6-naphthalenedicarboxylic acid and terephthalic acid (aromatic dicarboxylic acids) is 1.111.

Next, while distilling off by-produced acetic acid and unreacted acetic anhydride, the temperature was increased from 145° C. to 310° C. over 3 hours and 30 minutes, held at 310° C. for 120 minutes, and then the contents were drained into a SUS tray, and cooled to room temperature and solidified to obtain a liquid crystalline polyester (A7) in the form of a solid. The flow starting temperature of this liquid crystalline polyester (A7) was 267.9° C.

The liquid crystalline polyester (A7) has, based on the total amount (100 mol %) of all repeating structural units,
54 mol % of a structural unit (1) in which Ar1 is a 2,6-naphthylene group,
17 mol % of a structural unit (2) in which Ar2 is a 2,6-naphthylene group,
5 mol % of a structural unit (2) in which Ar2 is a 1,4-phenylene group, and
24 mol % of a repeating unit (3) in which Ar3 is a 1,4-phenylene group.

In the above liquid crystalline polyester (A7), the molar ratio of the structural unit derived from hydroquinone (aromatic diol)/the structural units derived from 2,6-naphthalenedicarboxylic acid and terephthalic acid (aromatic dicarboxylic acids) is 1.111.

The obtained liquid crystalline polyester was pulverized using a 2 mm perforated metal screen (pulverizing screen) and a pulverizer (model: VM-16, rotation speed: 1500 rpm) manufactured by Orient Pulverizer K.K. to obtain a liquid crystalline polyester powder of Comparative Example 3.

### <<Solid Phase Polymerization of Liquid Crystalline Polyester Powder>>

For 30 g of each of the liquid crystalline polyester powders of Examples and Comparative Examples, solid phase polymerization of the liquid crystalline polyester was carried out by carrying out a heat-treatment under a nitrogen atmosphere in which the temperature was increased from room temperature (23° C.) to 310° C. over 4 hours and was held at 310° C. for 2 hours.

For the liquid crystalline polyester powder after the solid phase polymerization, the endothermic peak position was measured using a differential scanning calorimeter to obtain the temperature (B) of the endothermic peak of the liquid crystalline polyester after the solid phase polymerization. Then, the value of the temperature (B) of the endothermic peak of the liquid crystalline polyester after the solid phase polymerization−the temperature (A) of the endothermic peak of the liquid crystalline polyester before the solid phase polymerization was determined, and the amount of temperature change (high temperature shift) from before the solid phase polymerization was calculated.

The measurement results for each of the above items are shown in Table 1.

TABLE 1

| | | | | | | Com- | Com- | Com- |
|---|---|---|---|---|---|---|---|---|
| | | Example | Example | Example | Example | parative | parative | parative |
| | | 1 | 2 | 3 | 4 | Example 1 | Example 2 | Example 3 |
| | Aromatic diol/aromatic | 0.828 | 0.875 | 0.909 | 0.946 | 1.030 | 1.044 | 1.111 |
| | dicarboxylic acid | | | | | | | |
| | molar ratio | | | | | | | |
| Measure- | Endothermic peak temperature A [° C.] | 274 | 281 | 280 | 291 | 301 | 299 | 297 |
| ment | Flow starting temperature [° C.] | 249.9 | 254.4 | 254.7 | 260.7 | 264.2 | 269.5 | 267.9 |
| results | Endothermic peak temperature B | 282 | 288 | 291 | 301 | 335 | 331 | 329 |
| | after solid phase polymerization [° C.] | | | | | | | |
| | High temperature shift of | 8 | 7 | 11 | 10 | 34 | 32 | 32 |
| | the endothermic peak (B-A) [° C.] | | | | | | | |

As shown in Table 1, in the liquid crystalline polyester powders of Examples 1 to 4 comprising liquid crystalline polyesters in which the molar ratio of the structural unit derived from an aromatic diol/the structural unit derived from an aromatic dicarboxylic acid is less than 1, the temperature change (high temperature shift) of the endothermic peak detected by differential scanning calorimetry after the solid phase polymerization was suppressed compared to the liquid crystalline polyester powders of Comparative Examples 1 to 3, which do not satisfy the above condition.

It can be said that the difficulty in causing a high temperature shift of the endothermic peak of the liquid crystalline polyester reflects the tendency of the liquid crystalline polyester to be difficult to cause a temperature increase in the melting temperature of the liquid crystalline polyester. Since the temperature increase in the endothermic peak of the liquid crystalline polyester is suppressed, a liquid crystalline polyester film obtained from the liquid crystalline polyester powder having such properties has excellent advantages that, even in the case of laminating another layer (for example, a copper foil) in a subsequent step, the liquid crystalline polyester is easily melted at a low temperature and the adhesive strength between the liquid crystalline polyester film and the copper foil after the lamination is easily enhanced.

Each configuration in each embodiment, a combination thereof, and the like are examples, and addition, omission, substitution of a configuration, and other modifications of a configuration are possible unless they depart from the object of the present invention. In addition, the present invention is not limited to each embodiment, but is limited only to the scope of the claims.

### REFERENCE SIGNS LIST

1 . . . liquid crystalline polyester powder, 3 . . . medium, 30 . . . liquid crystalline polyester composition, 10 . . . liquid crystalline polyester film, 12 . . . first support, 13 . . . second support, 14 . . . first metal layer, 15 . . . second metal layer, 22 . . . laminate precursor, 40 . . . liquid crystalline polyester film precursor, 20, 23 . . . first laminate, 21, 24 . . . second laminate

1. A liquid crystalline polyester powder comprising a liquid crystalline polyester having a structural unit derived from an aromatic diol and a structural unit derived from an aromatic dicarboxylic acid,
wherein a molar ratio of the structural unit derived from an aromatic diol/the structural unit derived from an aromatic dicarboxylic acid in the liquid crystalline polyester is less than 1.

2. The liquid crystalline polyester powder according to claim 1, wherein the liquid crystalline polyester has a flow starting temperature of 263° C. or lower.

3. The liquid crystalline polyester powder according to claim 1, wherein the liquid crystalline polyester has a structural unit comprising a naphthalene structure.

4. The liquid crystalline polyester powder according to claim 3, wherein a content of the structural unit comprising the naphthalene structure is 40 mol % or more based on 100 mol % of a total amount of all structural units in the liquid crystalline polyester.

5. The liquid crystalline polyester powder according to claim 1, wherein the liquid crystalline polyester has a structural unit represented by the following formula (1), a structural unit represented by the following formula (2), and a structural unit represented by the following formula (3):
—O—Ar1-CO— (1)
—CO—Ar2-CO— (2)
—O—Ar3-O— (3)
wherein Ar1 represents a 2,6-naphthylene group, a 1,4-phenylene group, or a 4,4′-biphenylylene group;
Ar2 and Ar3 each independently represent a 2,6-naphthylene group, a 2,7-naphthylene group, a 1,4-phenylene group, a 1,3-phenylene group, or a 4,4′-biphenylylene group; and
hydrogen atoms in the group represented by Ar1, Ar2, or Ar3 are each independently optionally replaced with a halogen atom, an alkyl group having 1 to 10 carbon atoms, or an aryl group having 6 to 20 carbon atoms.

6. The liquid crystalline polyester powder according to claim 5, wherein a molar ratio of the structural unit represented by the formula (3)/the structural unit represented by the formula (2) in the liquid crystalline polyester is less than 1.

7. A method for producing the liquid crystalline polyester powder according to claim 1, comprising
a step of obtaining the liquid crystalline polyester by using the aromatic diol and the aromatic dicarboxylic acid as monomers,
wherein a molar ratio of the aromatic diol/the aromatic dicarboxylic acid is less than 1.

8. A liquid crystalline polyester composition comprising a medium and the liquid crystalline polyester powder according to claim 1.

9. A method for producing a liquid crystalline polyester film, comprising: obtaining a liquid crystalline polyester film comprising the liquid crystalline polyester by applying the liquid crystalline polyester composition according to claim 8 onto a first support and heat-treating the liquid crystalline polyester composition.

10. A method for producing a laminate, comprising: obtaining a first laminate comprising a first support and a liquid crystalline polyester film by applying the liquid crystalline polyester composition according to claim 8 onto the first support and heat-treating the liquid crystalline polyester composition to form the liquid crystalline polyester film comprising the liquid crystalline polyester.

11. The method for producing a laminate according to claim 10, comprising laminating a second support on the surface of the liquid crystalline polyester film of the first laminate opposite to a surface on which the first support is laminated, heating the liquid crystalline polyester film, and bonding the liquid crystalline polyester film and the second support together to obtain a second laminate.

12. A liquid crystalline polyester film comprising a liquid crystalline polyester having a structural unit derived from an aromatic diol and a structural unit derived from an aromatic dicarboxylic acid,
wherein a molar ratio of the structural unit derived from an aromatic diol/the structural unit derived from an aromatic dicarboxylic acid in the liquid crystalline polyester is less than 1.

13. The liquid crystalline polyester film according to claim 12, wherein the liquid crystalline polyester has a structural unit comprising a naphthalene structure.

14. The liquid crystalline polyester film according to claim 13, wherein a content of the structural unit comprising a naphthalene structure is 40 mol % or more based on 100 mol % of a total amount of all structural units in the liquid crystalline polyester.

15. The liquid crystalline polyester film according to claim 12, wherein the liquid crystalline polyester has a structural unit represented by the following formula (1), a structural unit represented by the following formula (2), and a structural unit represented by the following formula (3):
—O—Ar1-CO— (1)
—CO—Ar2-CO— (2)
—O—Ar3-O— (3)
wherein Ar1 represents a 2,6-naphthylene group, a 1,4-phenylene group, or a 4,4′-biphenylylene group;
Ar2 and Ar3 each independently represent a 2,6-naphthylene group, a 2,7-naphthylene group, a 1,4-phenylene group, a 1,3-phenylene group, or a 4,4′-biphenylylene group; and
hydrogen atoms in the group represented by Ar1, Ar2, or Ar3 are each independently optionally replaced with a halogen atom, an alkyl group having 1 to 10 carbon atoms, or an aryl group having 6 to 20 carbon atoms.

16. The liquid crystalline polyester film according to claim 15, wherein a molar ratio of the structural unit represented by the formula (3)/the structural unit represented by the formula (2) in the liquid crystalline polyester is less than 1.

17. A laminate comprising a first metal layer and the liquid crystalline polyester film according to claim 12 laminated on the first metal layer.

18. The laminate comprising the first metal layer, the liquid crystalline polyester film according to claim 12 laminated on the first metal layer, and a second metal layer laminated on the surface of the liquid crystalline polyester film opposite to a surface on which the first metal layer is laminated.
